(19) United States
(12) Patent Application Publication
(10) Pub. No.: US 2026/0200203 A1
(43) Pub. Date: Jul. 16, 2026

(54) MULTI-LAYERED MATRIX AND USES THEREOF

(71) Applicant: NURAMI MEDICAL LTD., Haifa (IL)

(72) Inventors: Yaacov GVILI, Haifa (IL); Nora NSEIR MANASSA, Haifa (IL); Amir BAHAR, Qiryat Tivon (IL); Randa ABBAS, Daburiyya (IL)

(73) Assignee: NURAMI MEDICAL LTD., Haifa (IL)

(21) Appl. No.: 19/563,374

(22) Filed: Mar. 11, 2026

Related U.S. Application Data
(63) Continuation-in-part of application No. PCT/IL2024/050969, filed on Sep. 29, 2024.
(60) Provisional application No. 63/540,963, filed on Sep. 28, 2023.
(60) Provisional application No. 63/769,903, filed on Mar. 11, 2025.

(51) Int. Cl. B32B 5/02; B32B 27/08; B32B 37/10; B32B 37/18; B32B 38/00

(52) U.S. Cl. CPC B32B 5/02; B32B 27/08; B32B 37/10; B32B 37/182; B32B 38/164; B32B 2250/40; B32B 2307/51; B32B 2307/54; B32B 2307/7376; B32B 2309/64

(57) ABSTRACT

There is provided an article comprising a multi-layer matrix, said matrix comprising a viscoelastic polymeric film sandwiched between two or more layers of an elastic polymeric material; wherein each of said two or more layers of the elastic polymeric material is in a form of a fibrous mat; the fibrous mat (i) comprises a plurality of electrospun fibers characterized by an average cross-section between about 1 and about 5 micrometers, and (ii) is characterized by an average pore size between about 5 and about 50 micrometers; said viscoelastic polymeric film is characterized by a thickness between about 10 and about 60 um; said viscoelastic polymeric film is characterized by melting peak temperature of between 30 and about 45° C.; and the two or more layers of the elastic polymeric material comprise PLCL characterized by Mw of between 78 and about 100 kDa. Methods of manufacturing the article are also provided.

### CROSS-REFERENCE TO RELATED APPLICATIONS

This application is a continuation-in-part (CIP) of PCT Patent Application No. PCT/IL2024/050969, filed on Sep. 29, 2024, which claims the benefit of priority of U.S. Provisional Patent Application No. 63/540,963, titled “MULTI-LAYERED MATRIX AND USES THEREOF”, filed Sep. 28, 2023.

This application also claims the benefit of priority of U.S. Provisional Patent Application No. 63/769,903, filed on Mar. 11, 2025. The contents of all the above applications are all incorporated herein by reference in their entirety.

### FIELD OF THE INVENTION

The present invention, in some embodiments thereof, relates to a multi-layered fibrous matrix composed of biocompatible/degradable polymers, preparation and use thereof.

### BACKGROUND OF THE INVENTION

Leakage of liquid or air from or into a damaged tissue is a potentially life-threatening condition which may occur as a result of a wide variety of circumstances, including surgery and traumatic injury.

Soft tissues are particularly prone to damage. Additionally, these tissues sometimes create various compartments that hold liquid or air (e.g., lungs, blood vessels, dura matter, urinary bladder, etc.), and when damaged, their impairment can extend to other areas as well. Furthermore, because of the mechanical nature of these tissues, the attachment of a matrix with sutures or staples can cause damage in and of itself, e.g., to prevent proper sealing, to increase the probability of bacterial infection or to reduce the rate of recovery or recuperation. Examples of such soft tissues include dura mater, brain tissue, retina, skin tissue, hepatic tissue, pancreatic tissue, connective tissue, muscle tissue, cardiac tissue, vascular tissue, renal or urogenital tissue, pulmonary tissue, gonadal tissue, hematopoietic tissue, digestive tract tissue (such as colon or stomach) and fat tissue.

Although, various synthetic matrices based on synthetic and/or natural polymers for repairing or substituting dura matter are known in the art, there is still an unmet need for non-tissue adhesive polymer based articles characterized by sufficient strength and sealing capabilities.

### SUMMARY OF THE INVENTION

In one aspect of the present invention, there is provided a sterile article comprising a multi-layer matrix, the matrix comprising a viscoelastic polymeric film sandwiched between two or more layers of an elastic polymeric material; wherein each of the two or more layers of the elastic polymeric material is in a form of a fibrous mat; the fibrous mat (i) comprises a plurality of electrospun fibers characterized by an average cross-section between about 1 and about 5 micrometers, and (ii) is characterized by an average pore size between about 5 and about 50 micrometers; the viscoelastic polymeric film is characterized by a thickness between about 10 and about 60 μm; the viscoelastic polymeric film is characterized by (i) a melting onset temperature between about 32 and about 37° C., by (ii) melting peak temperature of between about 36 and about 45° C., or both (i) and (ii); the two or more layers of the elastic polymeric material comprise PLCL characterized by MW of between 78 and about 100 kDa.

In one embodiment, the article is characterized by a residual content of DMF below 88 ppm.

In one embodiment, the matrix is a suturable matrix, a stapleable matrix, or both; and wherein the viscoelastic polymeric film is a continuous film characterized by a uniform thickness.

In one embodiment, the sterile article is characterized by at least one of: (i) an average elongation at failure in a range of at least 200%; and (ii) by ultimate tensile strength of between 3.5 and 6 MPa, as determined in accordance with ASTM D882-12.

In one embodiment, the two or more layers of the elastic polymeric material comprise PLLA/CL characterized by MW of between 80 and 90 kDa and by Mz between about 150 and about 200 kDa.

In one embodiment, the matrix or the sterile article is characterized by elastic modulus in a range of from 0.5 to 2 MPa, as determined in accordance with ASTM international standard D882-12.

In one embodiment, the plurality of electrospun fibers is randomly distributed within the fibrous mat.

In one embodiment, the article is a beta-irradiated article.

In one embodiment, the article is characterized by burst pressure of at least 1.5 psi, when measured according to ASTM F2392-04.

In one embodiment, the fibrous mat is characterized by porosity in a range of from 40% to 70%.

In one embodiment, the article is characterized by at least one property selected from: ultimate tensile strength of between 3.2 and 8 MPa, when measured according to ASTM D882-12; elongation at failure from 200% to 700%, when measured according to ASTM D882-12; suture retention of at least 1.3N, when measured according to ANSI/AAMI/ISO 7198: 1998/2001/(R) 2004.

In one embodiment, the matrix, or each of the two or more layers of the elastic polymeric material is characterized by a self-recovery of at least 90%.

In one embodiment, the viscoelastic polymeric film comprises a PDLLA/CL characterized by a molar percentage of caprolactone between about 70 and about 80%.

In one embodiment, the MW of the PDLLA/CL is between about 20 and about 60 kDa; and wherein Mn of the PDLLA/CL is between about 10 and about 45 kDa.

In one embodiment, the article is identified for use in a treatment of a disorder selected from the group consisting of dural repair, hernia repair, internal and/or topical wound closure, skin closure and/or repair, sealing tissues and/or organs in order to contain bodily fluids or air, sealing an anastomosis, inhibition of post-surgical adhesions between tissues, promotion of hemostasis, treatment of burns, and administration of a therapeutically effective agent.

In another aspect, there is provided a method of manufacturing the sterile article of the invention, comprising providing a multi-layer matrix; and exposing the multi-layer matrix to beta irradiation under conditions suitable for sterilization of the matrix, thereby obtaining the sterile article; wherein the multi-layer matrix comprises a viscoelastic polymeric film sandwiched between two or more layers of an elastic polymeric material being in a form of a fibrous mat; the viscoelastic polymeric film comprises a PDLLA/CL characterized by a molar percentage of caprolactone between about 70 and about 80%, and by Mw of about 64 kDa; the fibrous mat (i) comprises a plurality of electrospun fibers characterized by an average cross-section between about 1 and about 5 micrometers, and (ii) is characterized by an average pore size between about 5 and about 50 micrometers; the viscoelastic polymeric film is characterized by a thickness between about 10 and about 60 um; the two or more layers of the elastic polymeric material comprise PLCL characterized by MW of between about 115 and about 120 kDa.

In one embodiment, the Mn of the PDLLA/CL is between about 40 and 45 kDa.

In one embodiment, the method further comprising a preliminary step of manufacturing the multi-layered matrix, the preliminary step comprises providing a first layer of the elastic polymeric material, a second layer of the elastic polymeric material and a viscoelastic polymeric film comprising a first surface and a second surface, wherein at least the first surface faces an ambient, wherein the viscoelastic polymeric film is between 70 and 300 um thick and comprises the PDLA/CL; contacting the first surface of the viscoelastic polymeric film with the first layer of the elastic polymeric material, thereby obtaining the viscoelastic polymeric film bound to the first layer of the elastic polymeric material; removing the viscoelastic polymeric film bound to the first layer of the elastic polymeric material from the support; contacting the first surface of the viscoelastic polymeric film with the second layer of the elastic polymeric material, thereby obtaining the multi-layered matrix.

In one embodiment, the contacting comprises applying pressure sufficient for binding at least one layer of the elastic polymeric material with at least one surface of the viscoelastic polymeric film.

In one embodiment, the method further comprises exposing the multi-layered matrix to conditions suitable for drying.

In one embodiment, the beta irradiation comprises a dose of between about 20 and 25 kGy.

In another aspect, there is provided a method of manufacturing the article of the invention, comprising forming a viscoelastic polymeric film by casting a polymeric solution comprising PDLLA/CL on a support material, wherein a solvent of said polymeric solution comprises between about 5 and about 15% v/v DMF; providing a first layer of the elastic polymeric material, a second layer of the elastic polymeric material and the viscoelastic polymeric film comprising a first surface and a second surface, wherein at least the first surface faces an ambient and the second surface is in contact with the support material, wherein said viscoelastic polymeric film is between 70 and 300 um thick and comprises PDLLA/CL; contacting said first surface of the viscoelastic polymeric film with the first layer of the elastic polymeric material, thereby obtaining the viscoelastic polymeric film bound to the first layer of the elastic polymeric material; removing the viscoelastic polymeric film bound to the first layer of the elastic polymeric material from the support material; contacting said first surface of the viscoelastic polymeric film with the second layer of the elastic polymeric material, thereby obtaining said multi-layered matrix.

In one embodiment, the contacting comprises applying pressure sufficient for binding at least one layer of the elastic polymeric material with at least one surface of the viscoelastic polymeric film; and wherein said pressure is at least 50 Pa.

In one embodiment, the method further comprises exposing said multi-layered matrix to conditions suitable for drying to obtain a dried matrix.

In one embodiment, the dried matrix is characterized by a total residual solvent content of below 0.5% by weight; and wherein the dried matrix is further characterized by residual DMF content below 88 ppm.

In one embodiment, the PDLLA/CL is characterized by a molar percentage of caprolactone (CL) between about 70 and about 80%, and by Mw between about 60 and 65 kDa.

In one embodiment, the viscoelastic polymeric film consists essentially of said PDLLA/CL and optionally one pre more organic solvent, and wherein said PDLLA/CL is characterized by Mw of about 64 kDa, by Mn between about 40 and 45 kDa and by CL content of about 75% mol.

In one embodiment, the PDLLA/CL is further characterized by: any one of (i) a melting peak temperature between 32.5 and 45° C., and (ii) inherent viscosity between 0.83 and 0.9 dl/g.

In one embodiment, Mw of the PLCL between about 115 and about 120 kDa.

In one embodiment, a molar content of caprolactone of the PLCL is between about 20 and about 40%.

In one embodiment, the casting comprises applying the polymeric solution on the support material to obtain a film further comprises a partial drying of the film, thereby obtaining a settled viscoelastic film; wherein said settled viscoelastic film is the viscoelastic polymeric film of claim 27.

In one embodiment, a concentration of PDLLA/CL within the polymeric solution is between 20 and 60% w/v.

In one embodiment, the solvent of said polymeric solution further comprises THF and dioxane, and wherein a concentration of DMF within the solvent is about 10% v/v.

In one embodiment, the film is characterized by a thickness of between 70 and 300 μm; and wherein a concentration of the PDLLA/CL within the polymeric solution is between 20 and 60% w/w.

The following embodiments and aspects thereof are described and illustrated in conjunction with systems, tools and methods which are meant to be exemplary and illustrative, not limiting in scope.

In addition to the exemplary aspects and embodiments described above, further aspects and embodiments will become apparent by study of the following detailed description.

### BRIEF DESCRIPTION OF THE DRAWINGS

FIG. 1 is a differential scanning calorimetry (DSC) graph of an exemplary matrix of the invention presenting melting temperature of PDCL.

FIGS. 2A-2D are light microscopy images showing a cross-section of an exemplary matrix of the invention before (2C) and after (2D) Swelling test, as well as a similar control matrix having a PDLCL-based film characterized by a Tm below 29° C. before (2A) and after (2B) Swelling test.

FIG. 3 is a bar graph presenting average viscosity of PDLCL solutions with decreasing concentrations of DMF.

### DETAILED DESCRIPTION OF THE INVENTION

The present invention, in some embodiments thereof, relates to tissue substitutes, and more particularly, but not exclusively, to an elastic layered matrix and to uses thereof as a tissue substitute.

Before explaining at least one embodiment of the invention in detail, it is to be understood that the invention is not necessarily limited in its application to the details of construction and the arrangement of the components and/or methods set forth in the following description and/or Examples. The invention is capable of other embodiments or of being practiced or carried out in various ways.

The present inventors have uncovered matrices which can exhibit a desired degree of biocompatibility, mechanical strength, flexibility and/or impermeability, and furthermore, can respond to punctures such as those formed by suturing or stapling in a manner which limits the detrimental effects thereof.

Embodiments of the present invention relate to liquid-impermeable layered matrices which exhibit a unique combination of mechanical and rheological properties and to uses thereof in a variety of medical applications, and specifically, but not exclusively, as implants, and particularly as tissue substitutes such as, but not limited to, dura substitutes. Embodiments of the present invention further relate to recoverable matrices, which upon being subjected to suturing or stapling, self-recover so as to seal the holes formed by such procedures.

As exemplified herein, layered matrices such as described herein (also referred to herein as “patches”) can be formed from biodegradable and biocompatible materials, while exhibiting considerable mechanical strength, a high degree of elasticity and flexibility, ease of handling, an ability to be folded (as may be useful for laparoscopic surgical procedures) without permanent deformation (e.g., without creasing), low density (which may decrease inflammation and infection), and a high degree of water-impermeability suitable for creating a tight seal, preventing fluid leakage, and preventing bacterial and viral infections.

According to one aspect of some embodiments of the invention, there is provided an article comprising a multi-layer matrix, the matrix comprising a viscoelastic polymeric film sandwiched between two or more layers of an elastic polymeric material; wherein: each of the two or more layers of the elastic polymeric material is in a form of a fibrous mat; the fibrous mat comprises a plurality of electrospun fibers characterized by an average cross-section between about 1 and about 5 micrometers; the viscoelastic polymeric film is characterized by a thickness between about 10 and about 60 um; the two or more layers of the elastic polymeric material comprise PLCL characterized by MW of between 78 and about 100 kDa.

According to another aspect of, there is provided an article comprising a multi-layer matrix, the matrix comprising a viscoelastic polymeric film sandwiched between two or more layers of an elastic polymeric material; wherein: each of the two or more layers of the elastic polymeric material is in a form of a fibrous mat; the fibrous mat (i) comprises a plurality of electrospun fibers characterized by an average cross-section between about 1 and about 5 micrometers, and (ii) is characterized by an average pore size between about 5 and about 50 micrometers; the viscoelastic polymeric film is characterized by a thickness between about 10 and about 60 um; the two or more layers of the elastic polymeric material comprise PLCL characterized by MW of between 78 and about 100 kDa; and the viscoelastic polymeric film is characterized by melting peak temperature of between 3° and 40° C.

According to another aspect of, there is provided an article comprising a multi-layer matrix, the matrix comprising a viscoelastic polymeric film sandwiched between two or more layers of an elastic polymeric material; wherein: each of the two or more layers of the elastic polymeric material is in a form of a fibrous mat; the fibrous mat comprises a plurality of electrospun fibers characterized by an average cross-section between about 1 and about 5 micrometers; the viscoelastic polymeric film comprises or consists essentially of PDLCL and is characterized by a thickness between about 10 and about 60 um; the two or more layers of the elastic polymeric material comprise or consist essentially of PLCL characterized by MW of between 78 and about 100 kDa; and the viscoelastic polymeric film is characterized by melting peak temperature of between 3° and 40° C.

According to one aspect of some embodiments of the invention, there is provided an article comprising a multi-layer matrix, the matrix comprising a viscoelastic polymeric film sandwiched between two or more layers of an elastic polymeric material; wherein: each of the two or more layers of the elastic polymeric material is in a form of a fibrous mat; the fibrous mat comprises a plurality of electrospun fibers characterized by an average cross-section between about 1 and about 5 micrometers; the viscoelastic polymeric film is characterized by a thickness between about 10 and about 60 um; the two or more layers of the elastic polymeric material comprise PLCL characterized by MW of between 78 and about 100 kDa and characterized by residual DMF content equal or below 88 ppm.

According to another aspect of, there is provided an article comprising a multi-layer matrix, the matrix comprising a viscoelastic polymeric film sandwiched between two or more layers of an elastic polymeric material; wherein: each of the two or more layers of the elastic polymeric material is in a form of a fibrous mat; the fibrous mat (i) comprises a plurality of electrospun fibers characterized by an average cross-section between about 1 and about 5 micrometers, and (ii) is characterized by an average pore size between about 5 and about 50 micrometers; the viscoelastic polymeric film is characterized by a thickness between about 10 and about 60 um; the two or more layers of the elastic polymeric material comprise PLCL characterized by MW of between 78 and about 100 kDa; and the viscoelastic polymeric film is characterized by melting peak temperature of between 3° and 40° C. and characterized by residual DMF content equal or below 88 ppm.

According to another aspect of, there is provided an article comprising a multi-layer matrix, the matrix comprising a viscoelastic polymeric film sandwiched between two or more layers of an elastic polymeric material; wherein: each of the two or more layers of the elastic polymeric material is in a form of a fibrous mat; the fibrous mat comprises a plurality of electrospun fibers characterized by an average cross-section between about 1 and about 5 micrometers; the viscoelastic polymeric film comprises or consists essentially of PDLCL and is characterized by a thickness between about 10 and about 60 um; the two or more layers of the elastic polymeric material comprise or consist essentially of PLCL characterized by MW of between 78 and about 100 kDa; and the viscoelastic polymeric film is characterized by melting peak temperature of between 30 and 40° C. and characterized by residual DMF content equal or below 88 ppm.

In some embodiments, the article of the invention is or consists essentially of the multi-layered matrix disclosed herein.

The terms “layered matrix”, “multi-layered matrix”, including any grammatical form thereof are used herein interchangeably.

In some embodiments, the article of the invention is a sterile article. In some embodiments, the article of the invention is a sterilized article. In some embodiments, the article of the invention is a beta radiation-sterilized article.

As used herein, the term “multi-layer” refers to a presence of at least two distinct layers. The distinct layers may differ, for example, in chemical composition, molecular configuration (e.g., degree and type of crystallinity), physical structure and/or mechanical properties.

Herein, the term “multi-layer matrix”, refers to the two or more elastic layers and viscoelastic layers (as described herein, according to any of the respective embodiments) and further includes any materials incorporated within and/or interposed between the elastic and/or viscoelastic layers. That is, the multi-layer matrix does not include any component of the composition-of-matter which is outside of (i.e., neither within nor between) the elastic and viscoelastic layers.

As used herein, the term “matrix” refers to elastic polymeric material consisting essentially of polymeric fibers (i.e. electrospun fibers) randomly distributed therewithin. Matrix encompasses any bulk 3D material, as opposed to a single polymer fiber, or to nano-sized material, such as 1D or 2D material. In some embodiments, the terms “fibrous mat” and “matrix” are used herein interchangeably. Matrix may further include any materials incorporated within. Alternatively, matrix may be devoid of any material incorporated within or interposed on or between the polymeric fibers within the matrix. In some embodiments, the matrix comprises randomly oriented polymeric fibers. In some embodiments, each polymeric fiber within the matrix is in contact with at least one additional polymeric fiber. In some embodiments, the polymeric fibers are randomly distributed within the matrix, so obtain a three-dimensional mesh structure comprising a void space between the fibers. In some embodiments, the polymeric fibers are randomly distributed within the matrix thus forming a plurality of pores (or void space).

In some embodiments, the terms “layer”, and “film” are used herein interchangeably, and refer to a material having a substantially uniform-thickness. In some embodiments, the term “layer” refers to a substantially homogeneous material characterized by a substantially the same chemical composition and/or substantially the same three-dimensional structure. In some embodiments, layer is characterized by a homogenous or uniform feature within the entire layer, wherein the feature is selected from spatial distribution of the polymeric fibers, fiber thickness, pore size, porosity, thickness, including any range between. In some embodiments, the term “entire layer” refers to at least 50%, at least 60%, at least 70%, at least 80%, at least 90%, at least 95%, at least 97% of the surface and/or volume of the layer, including any range between.

Herein, the terms “elasticity” and “elastic” refer to a tendency of a material (optionally in a form of a layer) to return to its original shape after being deformed by stress, for example, a tensile stress and/or shear stress, at an indicated temperature or at a temperature of 37° C. (in contexts wherein no temperature is indicated).

As used herein, the phrase “viscoelastic layer” refers to a layer of material, wherein the layer exhibits viscoelasticity.

Herein, the terms “viscoelasticity” and “viscoelastic” refer to a tendency of a material (optionally in a form of a layer) A viscoelastic material is one that exhibits both viscous and elastic characteristics when undergoing deformation. Viscous behavior allows the material to resist flow and dissipate energy, while elastic behavior enables it to return to its original shape after stress is removed.

A degree of viscoelasticity may optionally be characterized by a loss tangent (G″/G′), which is a ratio of a loss shear modulus (G″, also referred to herein interchangeably as a “shear loss modulus”) to storage shear modulus (G′, also referred to herein interchangeably as a “shear storage modulus”). The shear loss modulus reflects viscous behavior, whereas a storage shear modulus reflects elastic behavior. Loss tangent provides insight into the material's viscoelastic balance, with a higher ratio indicating a more viscous behavior and a lower ratio suggesting a more elastic behavior.

In viscoelastic materials, the behavior under stress can be characterized by two key moduli: the shear storage modulus (G′) and the shear loss modulus (G″). The shear storage modulus (G′) reflects the elastic behavior of the material, indicating its ability to store energy and return to its original shape after deformation. A higher G′ value suggests a more elastic response, where the material can recover its shape efficiently. Conversely, the shear loss modulus (G″) represents the viscous behavior, showing the material's tendency to dissipate energy as heat. A higher G″ value indicates greater energy loss during deformation, characteristic of a more viscous response.

In some embodiments, of any one of the embodiments described herein, a viscoelastic material (e.g., viscoelastic layer) is characterized in that a loss tangent of at least 0.01.

In some embodiments, of any one of the embodiments described herein, the viscoelastic polymeric film is characterized by a loss tangent which is greater than a loss tangent of the elastic layer. In some embodiments, a viscoelastic polymeric film is characterized by a loss tangent which is at least 200% of (two-fold) a loss tangent of the elastic layer.

Storage shear modulus and loss shear modulus may optionally be determined using a shear rheometer, for example, a strain-controlled rotational rheometer, at an indicated temperature and frequency (e.g., using procedures described in the Examples section herein).

Herein, the term “polymeric material” (including within the phrases “elastic polymeric material” and “viscoelastic polymeric film”) refer to a material comprising one or more polymers (as defined herein), wherein at least 20, at least 50, or at least 80 weight percents (by dry weight) of the material consists of the one or more polymer(s) disclosed herein.

### The Elastic Layer:

In some embodiments, the elastic layer is a porous layer. In some embodiments, the elastic layer is a fibrous layer or a fibrous mat. The terms “fibrous layer” and “fibrous mat” are used herein interchangeably. The fibers which form the elastic layers may be woven or non-woven. In some embodiments, the fibers are non-woven.

Herein, the term “porous layer” refers to a layer which comprises voids (e.g., in addition to polymeric material described herein), for example, the space between the polymeric material is not filled in by an additional substance. However, porous layers may optionally comprise an additional substance in the spaces between the polymeric material, provided that at least a portion of the volume of the voids is not filled in by the additional substance.

In some embodiments, each of the two or more elastic layers is a single-layer fibrous mat.

In some embodiments, each of the two or more elastic layers consists essentially of electrospun fibers. In some embodiments, at least 90% or between 95 and 100% by weight of the elastic layer consist of electrospun fibers. In some embodiments, the electrospun fibers are PLCL fibers. In some embodiments, the chemical composition of the two or more elastic layers is the same. In some embodiments, the two or more elastic layers have substantially identical structure (i.e. fiber thickness, porosity, layer thickness, etc.), wherein substantially encompasses variation of up to +/−20% between the elastic layers.

In some embodiments, at least 90% or between 95 and 100% by weight of the elastic layer consist of electrospun PLCL fibers. In some embodiments, the weight content of PLCL in the elastic layer is between 90 and 100%, between 95 and 99%, between 97 and 100%, by dry weight of the elastic layer. In some embodiments, the weight content of PLCL fibers in the elastic layer is between 90 and 100%, between 95 and 99%, between 97 and 100%, by dry weight of the elastic layer.

In some embodiments, the fibers of the elastic layer (i.e. PLCL fibers) are characterized by an average cross-section (or mean diameter) in a range from 1 to 5 μm (e.g. 1, 2, 3, 4 or 5, or between 1 and 3 μm, between 2 and 5 μm, including any range between.

In some embodiments, the PLCL within the article of the invention is characterized by MW of between 77 and about 110 kDa, between 78 and about 105 kkDa, between 78 and 100 kDa, between 80 and about 90 kDa, between 80 and 95 kDa, between 77 and 95 kDa, between 79 and 95 kDa, between 78 and 85 kDa, between 78 and 88 kDa, between 78 and 97 kDa, between 78 and 93 kDa, including any range between, wherein Mw refers to an average value determined by GPC. In some embodiments, the MW of the PLCL of the article of the invention is reduced by at least 10%, or between 10 and 30%, between 20 and 30% as compared to the same PLCL layer (or article comprising thereof) which has not been sterilized (e.g. a non-irradiated article).

In some embodiments, the PLCL within the article of the invention is characterized by Mn of between 45 and 70 kDa, between 47 and 70 kDa, between 47 and 60 kDa, between 47 and 55 kDa, between 47 and 52 kDa, including any range between, wherein Mn refers to an average value determined by GPC or viscosity based. In some embodiments, the Mn of the PLCL of the article of the invention is reduced by at least 10%, or between 10 and 35%, between 20 and 33%, between 25 and 33% as compared to the same PLCL layer (or article comprising thereof) which has not been sterilized (e.g. a non-irradiated article).

In some embodiments, the PLCL within the article of the invention is characterized by Mz of between 142 and 250 kDa, between 142 and 200 kDa, between 150 and 250 kDa, between 150 and 200 kDa, between 160 and 180 kDa, including any range between, wherein Mz refers to an average value determined by GPC, or viscosity based (calculated based on inherent viscosity). In some embodiments, the Mz of the PLCL of the article of the invention is reduced by at least 20%, at least 30, or between 10 and 40%, between 20 and 40%, between 25 and 37%, between 30 and 40, as compared to the same PLCL layer (or article comprising thereof) which has not been sterilized (e.g. a non-irradiated article).

In some embodiments, a molar percentage of caprolactone (i.e. polycaprolactone) within the PLCL is between about 20 and about 40%, between about 20 and about 35%, between 25 and 35, between 27 and 35, between 25 and 33, between 25 and 32, between 25 and 31, between 27 and 33, between 28 and 33, between 28 and 32, 30% or about 30%, including any range between.

In some embodiments, a molar percentage of lactide (i.e. poly-L-lactide) within the PLCL is between about 50 and about 90%, between about 60 and about 80%, between about 60 and about 75%, between 65 and 75, between 67 and 75, between 65 and 73, between 65 and 72, between 65 and 71, between 67 and 73, between 68 and 73, between 68 and 72, 70% or about 70%, including any range between.

In some embodiments, a molar percentage of lactide (i.e. poly-L-lactide) within the PLCL between about 60 and about 80%, and a molar percentage of caprolactone (i.e. polycaprolactone) within the PLCL is between about 20 and about 40%, respectively.

In some embodiments, the PLCL within the article of the invention is characterized by a melting peak temperature above 90° C., above 100° C., above 105° C., between 100 and about 120° C., between 10° and 115° C., between 11° and 120° C., between 11° and 115° C., including any range between, and wherein the melting peak temperature is determined by DSC. In some embodiments, a DSC graph of the article of the invention is characterized by at least one Tm peak corresponding to PLCL, wherein the at least one Tm peak is in a range between 100 and about 120° C.

In some embodiments, the PLCL/the elastic layer is characterized by a crystallinity of between 5 and 20%, between 8 and 20%, between 10 and 20%, between 8 and 15%, between 10 and 20%, between 10 and 15%, including any range between.

In some embodiments, each of the two or more elastic layers is characterized by average thickness in a range of from 20 to 500 μm, from 25 to 350 μm, from 80 to 200 μm, from 100 to 200 μm, or from 50 to 250 μm, including any range between. In some embodiments, each of the two or more elastic layers is characterized by average thickness in a range of from about 100 to about 200 μm.

In some embodiments, each of the two or more layers of elastic polymeric material is characterized by an average pore size between about 5 and about 50 micrometers, between about 10 and about 40 micrometers, between about 10 and about 30 micrometers, between about 20 and about 50 micrometers, including any range between.

In some embodiments, each of the two or more layers of elastic polymeric material is characterized by a porosity of at least 40%, or between 40 and 70%, between 50 and 70%, between 50 and 60%, between 40 and 60%, including any range between. Herein, the term “porosity” refers to a percentage of the volume of a substance (e.g., an elastic polymeric material described herein) which consists of voids.

In some embodiments, each of the two or more layers of elastic polymeric material is characterized by recovery, wherein “recovery” is as described below. In some embodiments, each of the two or more layers of elastic polymeric material is characterized by recovery and by self-recovery of least 80%, at least 85%, or between 80 and 99.9%, between 80 and 90%, between 80 and 99.9%, between 80 and 95%, between 90 and 97%, including any range between.

### The Viscoelastic Layer

A viscoelastic polymeric film according to any one of the embodiments described in this section described in this section may be combined with the elastic polymeric material according to any one of the respective embodiments described herein. In some embodiments, the viscoelastic polymeric film is in a form of a continuous layer, or a continuous film. In some embodiments, the viscoelastic polymeric film is a single layer film. In some embodiments, the viscoelastic polymeric film is a multi-layered film. In some embodiments, the viscoelastic polymeric film is devoid of fibers, and/or of a particulate matter. In some embodiments, the viscoelastic polymeric film is in a form of a continuous layer having a substantially uniform thickness (e.g. thickness variation of up to 20%). In some embodiments, the viscoelastic polymeric film is a homogenous material (e.g. characterized by substantially the same morphology, density, distribution or concentration of the polymer, and/or devoid of aggregates or particles having a particle size above 10 nm or above 100 nm within the entire material). In some embodiments, the viscoelastic polymeric film comprises (and optionally consists essentially of) one or more hydrophobic polymers.

In some embodiments, the viscoelastic polymeric film comprises a polymer characterized by a crystallinity of between 1 and 40%, between 1 and 10%, between 1 and 5%, between 1 and 15, between 5 and 20, between 5 and 15%, between 5 and 10% or between 1 and about 25%, including any range between.

In some embodiments, the viscoelastic polymeric film comprises a polymer (also used herein as “the viscoelastic polymer”) characterized by a melting peak temperature (Tm) above 29° C., above 30° C., between 30 and about 40° C., between 3° and 39° C., between 3° and 38° C., between 31 and 38° C., c including any range between.

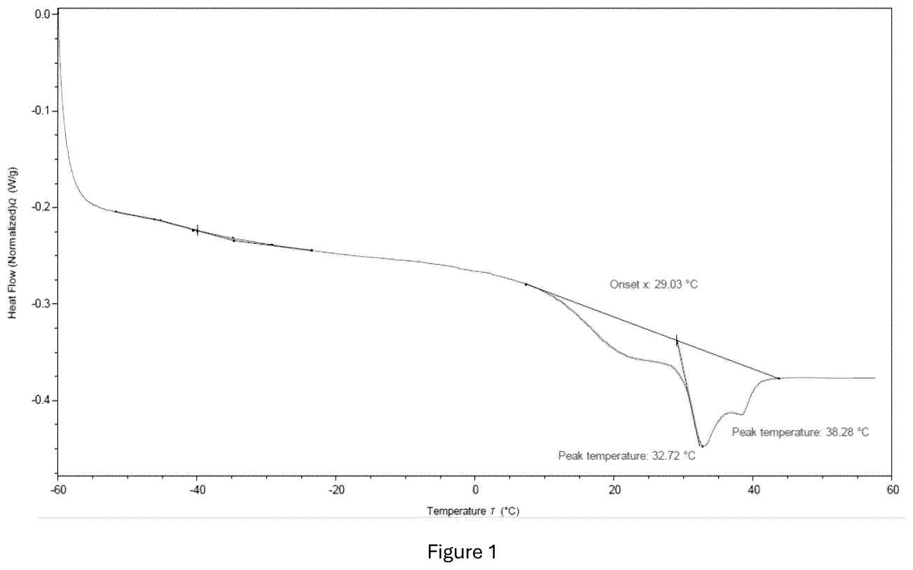

In some embodiments, a DSC graph of the article of the invention is characterized by at least one Tm corresponding to the viscoelastic polymer, wherein the at least one Tm is in a range between 3° and 40° C., between 3° and 38° C., between 30 and 35° C., between 3° and 33° C., between 31 and 35° C., between 31 and 37° C., between 31 and 38° C., between 31 and 39° C., between 31 and 40° C., including any range between. The melting peak temperature is determined by DSC, according to the conditions described in Materials and Methods. The Tm value of the viscoelastic polymer disclosed herein refers to: (i) at least one peak temperature, (ii) maximum peak temperature or (iii) average temperature, for example when more than one peak temperature is present in the corresponding DSC graph. FIG. 1 presents an exemplary DSC graph of an exemplary multi-layer matrix of the invention obtained using a DSC method disclosed in the Materials and Methods, showing Tm values of PDLCL, with a melting onset point at 29° C., a first Tm peak (maximum peak value) at 32.7° C. and an additional Tm peak at ~38° C. Accordingly, a skilled artisan will appreciate that based on the DSC graph, at least one peak (and max. peak) temperature of the tested PDLCL is at 32.7° C., and the average peak temperature is ~35.3° C.

In some embodiments, the viscoelastic polymer is PDLCL, characterized by (i) a molar percentage of caprolactone of about 75% and by (ii) a melting peak temperature between 30 and about 40° C. or between 31 and 35° C. (determined by DSC). In some embodiments, the melting peak temperature of PDLCL is the max. peak temperature.

In some embodiments, the viscoelastic polymer is PDLCL, characterized by (i) a molar percentage of caprolactone between about 70 and about 80%, or about 75%, (ii) a melting peak temperature (Tm) between 30 and about 40° C. or between 31 and 35° C. (determined by DSC), and (iii) by Mw between about 20 and about 60 kDa; and/or Mn between about 10 and about 45 kDa (determined by GPC or viscosity based).

In some embodiments, the viscoelastic polymeric film is characterized by a swelling ratio between about 0.9 and 1.8, between about 1 and 1.8, between about 1 and 1.7, between about 1.1 and 1.8, between about 1.2 and 1.7, between about 1.3 and 1.8, between about 1.2 and 1.6, or below 2, below 1.9, below 1.8 including any range between, wherein the swelling ratio refers to an average thickness ratio of the viscoelastic polymeric film after incubation in an aqueous solution relative to an average thickness ratio of the viscoelastic polymeric film in a dry article. Exact test conditions are as described in Materials and Methods.

In some embodiments, the viscoelastic polymeric film comprises or consists essentially of a hydrophobic polymer. In some embodiments, the viscoelastic polymer comprises or consists essentially of the hydrophobic polymer. Without being bound by any particular theory, it is believed that a hydrophobic polymer may considerably reduce water-permeability of the matrix. For example, pores in a porous hydrophobic viscoelastic polymeric layer may be too small to allow passage of water, as contact between the water and hydrophobic polymer is energetically unfavorable.

Herein, a “hydrophobic polymer” is a polymer characterized in that in water at a pH of 7.0, the polymer (in bulk) has a solubility of less than 1 gram per liter, and does not absorb more than 20 weight percents of water (weight of absorbed water relative to weight of polymer).

In some embodiments, the viscoelastic polymeric film comprises or consists essentially of a biodegradable and/or biocompatible polymer(s). In some embodiments, the viscoelastic polymer comprises or consists essentially of a biodegradable and/or biocompatible polymer(s). In some embodiments, the biodegradable and/or biocompatible polymer(s) is/are hydrophobic polymer(s). In some embodiments, the viscoelastic polymeric film comprises or consists essentially of a single polymer specie.

Preferred biodegradable polymers according to the present embodiments are non-toxic and benign biocompatible polymers. In some such embodiments, the biodegradable polymer is a bioresorbable polymers which decomposes into non-toxic and benign breakdown products that are absorbed in the biochemical systems of the subject.

Non-limiting examples of biodegradable polymers which are suitable for use as the viscoelastic polymer include homo-polymers and co-polymers such as aliphatic polyesters made of glycolide (glycolic acid), lactide (lactic acid, including L-lactic acid and/or D-lactic acid), ε-caprolactone, dioxanone (e.g., p-dioxanone), trimethylene carbonate, hydroxybutyrate and/or hydroxyvalerate; polypeptides made of natural and/or modified amino acids (e.g., collagen, alginate, elastin, elastin-like polypeptides, albumin, fibrin, chitosan, silk, poly(γ-glutamic acid) and polylysine); polysaccharides made of natural and/or modified saccharides (e.g., hyaluronic acid); polydepsipeptides; biodegradable nylon co-polyamides; polydihydropyrans; polyphosphazenes; poly(orthoesters); poly(cyanoacrylates); polyanhydrides; polyurethanes, polycarbonates, silicones, polyamides (e.g., nylons), polysulfones, polyether ether ketones (PEEKs), polytetrafluoroethylene, polyethylene, poly(methyl methacrylate), poly(ethyl methacrylate), poly(methyl acrylate), poly(ethyl acrylate) and non-biodegradable polyesters such as, for example, poly(ethylene terephthalate), including any copolymer thereof and any combination thereof.

While any polymer, copolymer or a mixture of polymers and/or copolymers can be used for producing the elastic and/or viscoelastic polymeric film described herein, according to some embodiments of any one of the embodiments described herein relating to elastic and/or viscoelastic polymeric film, the elastic and/or viscoelastic polymeric film is formed of a biocompatible and/or biodegradable polymer.

In some embodiments, the viscoelastic polymeric film comprises or consists essentially of poly (DL-lactic acid-co-&-caprolactone) (abbreviated as PDLLA/CL or PDLCL). In some embodiments, the viscoelastic polymer comprises or consists essentially of PDLCL. In some embodiments, PDLLA/CL constitutes between 80 and 100%, between 90 and 100, between 95 and 100, between 80 and 95%, between 80 and 99%, between 95 and 99% by dry weight of the polymeric content of the viscoelastic polymeric film. In some embodiments, PDLLA/CL constitutes between 80 and 100%, between 90 and 100, between 95 and 100, between 80 and 95%, between 80 and 99%, between 95 and 99% by dry weight of the viscoelastic polymeric film. In some embodiments, the viscoelastic polymeric film consists essentially of PDLLA/CL (and optionally comprises residual amount of additional polymer, small molecule or solvent, wherein residual amount is up to 0.1% by weight).

In some embodiments, PDLLA/CL characterized by a molar percentage of caprolactone between about 70 and about 80%, between about 72 and about 80%, between about 74 and about 80%, between about 70 and 78%, between about 72 and 78%, between about 70 and 77%, between about 70 and about 75%, between about 80 and 75%, between about 73 and 77%, between about 73 and 76%, between 74 and 77%, between 74 and 76%, or about 75, including any range between. In some embodiments, PDLLA/CL characterized by a molar percentage of PDLLA between about 20 and about 30%, between about 20 and about 40%, between about 20 and about 26%, between 22 and 28, between 23 and 26, between 20 and 27, between 23 and 27, between 24 and 26, 25% or about 25%, including any range between.

In some embodiments, PDLLA/CL is further characterized by Mw between about 20 and about 60 kDa, between 20 and 64 kDa, between 20 and 60 kDa, between 20 and 55 kDa, between 20 and 50 kDa, between 20 and 40 kDa, between 40 and 64 kDa, between 40 and 60 kDa, between 40 and 55 kDa, between 40 and 50 kDa, or below 64 kDa, below 62 kDa, below 60 kDa, below 58 kDa, below 55 kDa, below 50 kDa, including any range between.

In some embodiments, PDLLA/CL is further characterized by Mn between about 10 and about 40 kDa, between 10 and 41 kDa, between 10 and 40 kDa, between 20 and 35 kDa, between 20 and 30 kDa, between 10 and 40 kDa, between 10 and 35 kDa, between 10 and 30 kDa, or below 42 kDa, below 40 kDa, below 38 kDa, including any range between.

In some embodiments, PDLLA/CL is further characterized by Mz between about 30 and about 90 kDa, between 30 and 94 kDa, between 30 and 90 kDa, between 30 and 85 kDa, between 30 and 80 kDa, or below 95 kDa, below 90 kDa, below 92 kDa, including any range between.

In some embodiments, the viscoelastic polymeric film consists essentially of PDLLA/CL, wherein PDLLA/CL is characterized by a molar percentage of caprolactone between about 70 and about 80%, by Mw between 20 and 60 kDa, by at least one Tm value in a range between 3° and 40° C. and optionally by Mn and/or Mz, as described hereinabove. The terms Mw, Mn, and/or Mz as used herein refer to average values and are determined based on GPC, or viscosity based.

In some embodiments, the viscoelastic polymeric film is a non-porous, continuous film or is characterized by a limited porosity. In some embodiments, the viscoelastic polymeric film is characterized by a porosity which is lower than a porosity of each of the adjacent two or more layers of an elastic polymeric material.

In some such embodiments, the viscoelastic polymeric film is characterized by a porosity which is less than 20%, less than 10%, or less than 5% of the porosity of each of the adjacent two or more layers of an elastic polymeric material.

In some embodiments, a viscoelastic polymeric film is characterized by a porosity in a range of from 0 to 50%, from 0 to 30%, or from 0 to 10%, including any range between.

Without being bound by any particular theory, it is believed that a viscoelastic polymeric film which is non-porous or characterized by limited porosity reduces a permeability of the core matrix to water as well as other liquids, thereby enhancing the ability of the composition-of-matter to serve, for example, as a sealant against fluid leakage. It is further believed that such a layer, for example, a layer which does not have any fibrous structure, can readily undergo deformation in response to stress by viscous flow, and that such deformation can result in closure of holes formed in the viscoelastic layer.

In some embodiments, a viscoelastic polymeric film is characterized by average thickness in a range of from 10 to 60 μm, between 10 and 50 μm, between 10 and 40 μm, between 20 and 60 μm, between 30 and 60 μm, between 10 and 30 μm, between 20 and 40 μm, including any range between.

Based on extensive experiments, the inventors have surprisingly found that the thickness range of the viscoelastic polymeric film of between 10 and 60 μm is essential for optimal burst strength (and as a consequence for sealing capabilities) of the matrix disclosed herein. Moreover, Example 3 provides additional experimental results pointing out the significance of the thickness range of the viscoelastic polymeric film disclosed above.

Herein, the terms “viscoelasticity” and “viscoelastic” refer to a tendency of a material (optionally in a form of a layer) to resist stress to a degree which correlates with the rate of deformation (e.g., strain, shear), at an indicated temperature or at a temperature of 37° C. (in contexts wherein no temperature is indicated). That is, when deformation is effected relatively slowly, the resistance of the material is lower (e.g., due to viscous flow during deformation), and the resistance may optionally approach zero as the rate of deformation (e.g., shear) approaches zero. The resistance will typically not be sufficient to allow the material to return to its original shape, except in some cases wherein the rate of deformation is very high.

A degree of viscoelasticity may optionally be characterized by a loss tangent (G″/G′), which is a ratio of a loss shear modulus (G″, also referred to herein interchangeably as a “shear loss modulus”) to storage shear modulus (G′, also referred to herein interchangeably as a “shear storage modulus”). A loss shear modulus reflects viscous behavior, whereas a storage shear modulus reflects elastic behavior.

In some embodiments, of any one of the embodiments described herein, viscoelastic polymeric film is characterized by a loss tangent of at least 0.01.

In some embodiments, of any one of the embodiments described herein, the viscoelastic polymeric film is characterized by a loss tangent which is greater than a loss tangent of the elastic layer. In some embodiments, a viscoelastic layer is characterized by a loss tangent which is at least 200% of (two-fold) a loss tangent of the elastic layer.

Storage shear modulus and loss shear modulus may optionally be determined using a shear rheometer, for example, a strain-controlled rotational rheometer, at an indicated temperature and frequency (e.g., using procedures described in the Examples section herein).

### Matrix

In some embodiments, the matrix of the invention is a multilayer matrix comprising the viscoelastic polymeric film (e.g. a single layer film) interposed or sandwiched between two adjacent layers of the elastic polymeric material. The terms “multi-layer matrix” and “matrix are used herein interchangeable.

In some embodiments, each of two adjacent layers of the elastic polymeric material is independently a single layer fibrous mat, or is a multi-layer fibrous mat as described hereinabove. In some embodiments, each of two adjacent layers is in contact with each of the outer surfaces of the viscoelastic polymeric film, respectively. In some embodiments, each of two adjacent layers is stably bound to the viscoelastic polymeric film.

In some embodiments, the term “stably bound” encompasses that the matrix is stable (maintains its physical multilayered structure, its mechanical or functional integrity and doesn't undergo disintegration) as determined by visual inspection under microscope. In some embodiments, the term “stably bound” encompasses matrix stability upon storage thereof under ambient conditions (e.g. in an air tight or a sealed container at a temperature between 5 and 30° C.) for at least 0.5, at least 1, at least 1.5 years.

In some embodiments, the matrix comprises a boundary region in close proximity to the contact point between the adjacent layers of the matrix (i.e. between the viscoelastic polymeric film and the fibrous mat), optionally wherein the boundary region has a thickness between 1 and 20 um. In some embodiments, the boundary region is characterized by partial penetration or incorporation of the elastic polymeric material fibers into the viscoelastic polymeric film, and/or vice versa.

Without being bound by any particular theory, it is believed that a location of a viscoelastic polymeric film between elastic layers, allows the elastic layers to contain the viscoelastic polymeric film within the matrix, and prevent significant leaching of the viscoelastic polymeric film. It is further believed that a viscoelastic polymeric film is in a form of an intermediate layer is highly suitable for acting as a barrier and for closing holes, as described herein, while being effectively contained by the elastic layers.

In some embodiments, the matrix has a sheet-like geometry. In some embodiments, the matrix is in a form of a continuous layer. In some embodiments, the matrix is in a form of a continuous uniform layer, characterized by substantially uniform thickness.

In some embodiments, the sheet-like geometry is characterized in that average thickness in one dimension (e.g., a mean width in the dimension in which the matrix is narrowest) is less than 20%, less than 10%, less than 5% or between 0.1 and 20% of a mean width in each of two perpendicular dimensions.

In some embodiments, the matrix is characterized by average thickness between 100 μm and 3 mm.

In some embodiments, a mean total thickness of the two or more layers of an elastic polymeric material is at least 50%, or between 50 and 90% of the average thickness of the matrix.

In some embodiments, the article is in a form of a patch. In some embodiments, the article is in a form of a tissue patch (e.g. topical patch). In some embodiments, the article is for topical application on a tissue of a subject. In some embodiments, the article is in a form of a ready-to-use topical patch.

In some embodiments, the article is in a form of a patch characterized by at least one of: length between 1 and 10; width between 1 and 10, and thickness between 0.1 and 3 mm, including nay range between.

In some embodiments, a DSC graph of the article of the invention is characterized by (i) at least one Tm peak corresponding to PLCL in a range between 100 and about 120° C., and (ii) by at least one Tm peak corresponding to the viscoelastic polymer (PDLCL) in a range between 3° and 38° C.

In some embodiments, the article is identified for use in a treatment of a disorder in the subject. In some embodiments, the disorder is selected from the group consisting of dural repair, hernia repair, internal and/or topical wound closure, skin closure and/or repair, sealing tissues and/or organs in order to contain bodily fluids or air, sealing an anastomosis, inhibition of post-surgical adhesions between tissues, promotion of hemostasis, treatment of burns, and administration of a therapeutically effective agent.

In some embodiments, the article is packaged in a sealed package. In some embodiments, the sealed package is a gas tight (e.g. air tight) package. In some embodiments, the sealed package is a gas permeable package, and is impermeable to pathogens (e.g. air-born pathogens such as viruses, bacteria, fungi, including spores thereof). The sealed packages for sterile articles involve materials and designs that ensure the integrity and sterility of the contents. These packages may include features to prevent contamination and facilitate sterilization. Examples of Sealed Packages include but are not limited to: 1. Tyvek® Pouches: Made from high-density polyethylene fibers, Tyvek® is breathable yet resistant to microorganisms, making it ideal for sterilization processes like ethylene oxide and gamma irradiation. 2. Foil-Laminated Pouches: These pouches combine layers of aluminum foil with plastic films, providing excellent barrier properties against moisture, light, and gases. They are often used for products requiring a high level of protection. 3. Polypropylene Blister Packs: These packs are formed from rigid polypropylene, offering a clear view of the product while providing a strong barrier against contaminants. They are commonly used for medical devices and pharmaceuticals. 4. Nylon/Polyethylene Bags: These bags offer a combination of strength and flexibility, with nylon providing puncture resistance and polyethylene offering a moisture barrier. They are suitable for vacuum sealing. 5. PET/Aluminum/LDPE Laminates: This multi-layer structure provides excellent barrier properties and is used for products that require protection from oxygen and moisture. These packaging options are selected based on the specific requirements of the sterile article, including the type of sterilization process, the need for visibility, and the level of barrier protection required.

In some embodiments, the article is a sterile or sterilized article. In some embodiments, the matrix is a sterile or sterilized matrix. In some embodiments, the sterile matrix is in a form of a sterile or a sterilized article with a defined shape, and/or dimensions. In some embodiments, the sterile or a sterilized article consists essentially of the matrix (i.e. sterile matrix) of the invention. In some embodiments, the matrix is a beta-sterilized matrix. In some embodiments, the beta-sterilized matrix is obtained by sterilizing the matrix (i.e. a non-sterile matrix) by beta-radiation at a dose sufficient for sterilization thereof.

As used herein, the terms “sterile” and sterilized are used herein interchangeably.

The term “sterile” as used herein, refers inter alia to the maximum microbial load threshold of the matrix of the invention, according to the sterility requirements for medical articles/devices as recorded in US Pharmacopoeia, or in European Pharmacopoeia, respectively (i.e. 0 CFU). Exemplary sterility test may involve incubation of the article in a nutrient-rich medium to detect microbial contamination. The test is typically conducted under aseptic conditions to prevent external contamination.

The article is placed in a sterile container with a nutrient medium, such as Tryptic Soy Broth (TSB) or Fluid Thioglycollate Medium (FTM). The container is incubated at specific temperatures, usually 20-25° C. for fungi and 30-35° C. for bacteria, for a period of 14 days. The medium is tested to determine microbial growth (by counting CFU of the tested microorganisms), indicating contamination.

The tested pathogens are usually as follows: (i) Bacteria pathogens including Staphylococcus aureus, Pseudomonas aeruginosa, Bacillus subtilis, etc.; (ii) Fungi pathogens including Candida albicans, Aspergillus brasiliensis etc. This test ensures that the article is free from viable microorganisms (0 CFU for each of the tested microorganisms), confirming its sterility according to pharmacopeial standards.

In some embodiments, the sterilized article comprises the matrix/article of the invention which has been exposed to beta-radiation at a dose sufficient for sterilization thereof. In some embodiments, the dose is sufficient for obtaining a sterile matrix/article of the invention, wherein “sterile” is as described herein. In some embodiments, the dose is sufficient for reducing microbial load of an un-sterilized matrix/article, so as to obtain a sterile matrix/article. Beta-radiation sterilization can be performed by applying high energy electron beam to a non-sterilized matrix (e.g. a matrix after manufacturing thereof).

The inventors surprisingly found that matrices of the invention sterilized by beta-radiation exhibited superior mechanical properties, as compared to similar gamma-irradiated matrices.

In some embodiments, the beta-radiation dose sufficient for sterilization is between 10 and 50 kGy, between 20 and 25 kGy, between 15 and 25 kGy, between 15 and 30 kGy, including any range between. The “dose” refers to the radiation exposure of the article.

In some embodiments, the matrix (i.e. sterilized matrix) is characterized by reduced MW and/or Mn of the PLLA/CL and/or PDLLA/CL, as compared to a similar non-sterilized matrix, wherein reduced is as described above.

In some embodiments, the matrix (i.e. sterilized matrix) is characterized by self-recovery. In some embodiments, the self-recovery of the matrix is at least 90%, or between 90 and 99%.

Herein, the term “self-recovery” refers to an ability of a material (e.g., material in the matrix) to at least partially close a hole formed in the material (optionally by a 21-gauge needle) by movement of a portion of the material into the space of the hole (e.g., by elastic rebound and/or plastic deformation), such that a hole remaining in the material the needle (if any) is less than 50% of an area of a cross-section of the object which formed the hole (e.g., optionally by a 21-gauge needle). Self-recovery is measured under ambient conditions (pressure of about 1 atm and a temperature between 19 and 37° C.)

In some embodiments, the matrix (i.e. sterilized matrix) is a suturable and/or stapleable matrix capable of self-recovery.

Herein, the term “suturable” refers to an ability to have a needle pass through the matrix without causing a rupture (e.g., a crack or tear) in the matrix other than a localized hole similar in area to the needle cross-section.

Herein, the term “stapleable” refers to an ability to have a staple pass through the matrix without causing a rupture (e.g., a crack or tear) in the matrix other than a localized hole similar in area to the staple cross-section.

The needle and staple in the above definitions of “suturable” and “stapleable” have a cross-section (optionally, a circular cross-section) of no more than 1 mm2. Optionally, the needle is a 21-gauge needle (diameter ~0.51 mm).

Without being bound by any particular theory, it is believed that a fibrous structure of an elastic layer made of polymeric fibers advantageously allows a needle to pass through the layer by pushing fibers aside without any considerable amount of permanent deformation or mechanical disruption of the layers, and that the elasticity of the fibers causes the layers to rebound, thereby closing suture holes and holding tightly to sutures.

In some embodiments, the matrix (i.e. sterilized matrix) is characterized by at least one of: (i) an average elongation at failure of at least 200%; and (ii) by ultimate tensile strength (UTS) of between 3.2 and 6 MPa, as determined in accordance with ASTM D882-12, or by a combination of (i) and (ii).

In some embodiments, the matrix (i.e. sterilized matrix) is characterized by an average elongation at failure of at least 200%, at least 250%, at least 300%, at least 350%, at least 450%, or between 300 and 700%, between 350 and 700%, between 400 and 700%, between 450 and 700%, between 450 and 600%, including any range between, wherein the elongation at failure is measured in accordance with ASTM D882-12. In some embodiments, the matrix (i.e. sterilized matrix) is characterized by elongation at failure of at least 200%, at least 250%, at least 300%, at least 350%, at least 450%, or between 300 and 700%, between 350 and 700%, between 400 and 700%, between 450 and 700%, between 450 and 600%, including any range between, wherein the elongation at failure is measured in accordance with ASTM D882-12.

In some embodiments, the matrix (i.e. sterilized matrix) is characterized by an average UTS between 3.2 and 8 MPa, between 3.2 and 7 MPa, between 4 and 8 MPa, between 5 and 8 MPa, between 5 and 7 MPa, between 3.5 and 7 MPa, between 3.5 and 6 MPa, between 4 and 6 MPa, or between 5 and 6 MPa, including any range between, wherein the UTS is measured in accordance with ASTM D882-12. In some embodiments, the matrix (i.e. sterilized matrix) is characterized by UTS between 3.2 and 8 MPa, between 3.2 and 7 MPa, between 4 and 8 MPa, between 5 and 8 MPa, between 5 and 7 MPa, between 3.5 and 7 MPa, between 3.5 and 6 MPa, between 4 and 6 MPa, or between 5 and 6 MPa, including any range between, wherein the UTS is measured in accordance with ASTM D882-12.

In some embodiments, the matrix (i.e. sterilized matrix) is characterized by an average elongation at failure and by average UTS as disclosed above. The terms “average elongation” and “average UTS” encompass an average value obtain from at least 10 measurements.

In some embodiments, the matrix (i.e. sterilized matrix) is characterized by any of the properties disclosed in Table 1 below.

TABLE 1
Non-limiting exemplary mechanical properties
of the matrix of the invention

| Test | n(tests) | Mean |
|---|---|---|
| Stress at Maximum Load [MPa] - | 60 | ~4-7 |
| Accumulated Results (wet and dry | | |
| articles) | | |
| Strain at Maximum Load [%] - | 60 | ~400-550 |
| Accumulated Results (wet and dry | | |
| articles) | | |

“wet article” refers to a test article immersed in saline for 15 min prior to performing a corresponding test measurement.

In some embodiments, the matrix (i.e. sterilized matrix) is characterized by elastic modulus in a range of from 0.5 to 2 MPa, from 0.5 to 1 MPa, from 0.5 to 1.5 MPa, from 0.8 to 2 MPa, from 0.8 to 1.5 MPa, including any range between as determined in accordance with ASTM international standard D882-12.

In some embodiments, the matrix (i.e. sterilized matrix) described herein is characterized by burst pressure of at least 1.1 psi, at least 1.5 psi, at least 2 psi, or between 1.1 and 6 psi, between 1.5 and 6 psi, between 2 and 6 psi, including any range between when measured according to ASTM F2392-04.

In some embodiments, the matrix (i.e. sterilized matrix) is characterized by burst pressure disclosed in Table 2 below.

TABLE 2
Non-limiting exemplary burst pressure
values of the matrix of the invention

| Test | n (tests) | Mean (psi) |
|---|---|---|
| Burst pressure - Dry Articles | 42 | ~3-5 |
| Burst pressure - Wet Articles | 12 | ~3-5.5 |

“wet article” refers to a test article immersed in saline for 15 min prior to performing a corresponding test measurement.

In some embodiments, the matrix (i.e. sterilized matrix) described herein is characterized by a suture retention at least 1.3N, at least 1.5N, or between 1.2 and about 3N, between about 1.2 and about 2.8, when measured according to ANSI/AAMI/ISO 7198: 1998/2001/(R) 2004. In some embodiments, the matrix (i.e. sterilized matrix) described herein is characterized by an average suture retention of at least 1.3N, at least 1.5N, or between 1.3 and about 2N, when measured according to ANSI/AAMI/ISO 7198: 1998/2001/(R) 2004. In some embodiments, the matrix (i.e. sterilized matrix) described herein is characterized by an average suture retention of at least 1.3N, or between 1.4 and about 2.5N, when measured according to ANSI/AAMI/ISO 7198: 1998/2001/(R) 2004 for a dry article.

In some embodiments, the matrix (i.e. sterilized matrix) described herein is characterized by at least one, at least two property(s) selected from: ultimate tensile strength of between 3.2 and 8 MPa, when measured according to ASTM D882-12; elongation at failure from 200% to 700%, when measured according to ASTM D882-12; and suture retention of between 1.3N and about 3N, when measured according to ANSI/AAMI/ISO 7198: 1998/2001/(R) 2004.

In some embodiments, the article and/or the matrix further comprises at least one additional ingredient (also referred to herein as “additive”) which imparts an additional functionality.

In some such embodiments, the additional ingredient(s) is in a form of at least one additional layer. The additional layer(s) is optionally on at least a portion of at least one surface of the core matrix and/or within the core matrix (e.g., between two other layers of the core matrix, as described herein).

Alternatively or additionally, in some embodiments, the additional ingredient(s) is dispersed within the core matrix and/or present on at least one surface, or a portion thereof, of the matrix.

Except where indicated otherwise, an additional ingredient is considered herein as part of the matrix when present within the core matrix, but not when present outside the matrix (e.g., on a surface or a portion of a surface of the matrix).

Examples of additional functionalities which may be imparted by an additional ingredient include, without limitation, water-impermeability, which may optionally be provided by an additive in a form of a water-impermeable layer and/or by a hydrophobic additive); inhibition of formation of an adhesion to tissue, which may be optionally be provided by an additive characterized by reduced adhesion to tissue, and/or by an agent which inhibits cell growth; reduction of risk of infection, which may optionally be provided by an antimicrobial agent, such as an antibiotic, and/or by a film which inhibits penetration of pathogens; reduction of risk of tissue rejection and/or immune response, which may optionally be provided by an agent which modulates an immune system; and adhesion to tissue without suturing, which may optionally be provided by an adhesive (e.g., applied on a surface) and/or an agent and/or surface which promotes cell growth and/or attachment (e.g., growth factors, extracellular matrix proteins, and/or other proteins). Examples of layers which may be formed from additional ingredients which impart such functionalities include, without limitation, water-impermeable layers, tissue-adhesive layers (i.e., layers characterized by enhanced adherence to cells, as compared with the core matrix without a tissue-adhesive layer), cell growth-promoting layers and anti-fouling layers (i.e., layers characterized by reduced adherence to cells, as compared with the core matrix without an anti-fouling layer).

Examples of additional ingredients which may be included in the composition-of-matter ingredient include, without limitation, adhesive materials, non-adhesive materials (e.g., materials characterize by particularly low adherence to tissue and/or other substrate), hydrophobic polymer particles, biological and/or bio-active materials, cellular components (e.g., a cell signaling protein, an extracellular matrix protein, a cell adhesion protein, a growth factor, protein A, a protease and a protease substrate), growth factors and therapeutically active agents.

Additional ingredients (e.g., therapeutically active agents) which can be beneficially incorporated into the composition-of-matter include both natural or synthetic polymeric (macro-biomolecules, for example, proteins, enzymes) and non-polymeric (small molecule therapeutics) natural or synthetic agents.

Examples of suitable therapeutically active agents include, without limitation, antiproliferative agents, cytotoxic factors or cell cycle inhibitors, including CD inhibitors, such as p53, thymidine kinase (“TK”) and other agents useful for interfering with cell proliferation.

Examples of therapeutically active agents that inhibit cell proliferation and/or angiogenesis (antiproliferative drugs) which are particularly useful in drug-eluting systems destined for anticancer treatment, include paclitaxel, sirolimus (rapamycin), farnesylthiosalicylate (FTS, salirasib), fluoro-FTS, everolimus, zotarolimus, daunorubicin, doxorubicin, N-(5,5-diacetoxypentyl) doxorubicin, anthracycline, mitomycin C, mitomycin A, 9-amino camptothecin, aminopertin, antinomycin, N8-acetyl spermidine, 1-(2-chloroethyl)-1,2-dimethanesulfonyl hydrazine, bleomycin, tallysomucin, etoposide, camptothecin, irinotecan, topotecan, 9-amino camptothecin, paclitaxel, docetaxel, esperamycin, 1,8-dihydroxy-bicyclo[7.3.1]trideca-4-ene-2,6-diyne-13-one, anguidine, morpholino-doxorubicin, vincristine, vinblastine and derivatives thereof.

Additional therapeutically active agents which can be beneficially incorporated into the composition-of-matter include antibiotic agents. Non-limiting examples of suitable antibiotic agents include gentamicin, ceftazidime, mafenide benzoyl peroxide, octopirox, erythromycin, zinc, silver, tetracyclin, triclosan, azelaic acid and its derivatives, phenoxyethanol and phenoxypropanol, ethyl acetate, clindamycin and meclocycline; sebostats such as flavinoids; alpha and beta hydroxy acids; polydiallyldimethylammonium chloride and bile salts such as scymnol sulfate and its derivatives, deoxycholate and cholate.

Additional therapeutically active agents which can be beneficially incorporated into the composition-of-matter include analgesic agents, anaesthetic agents, pain-killers, pain-reducers and the like (including NTHEs, COX-2 inhibitors, K+ channel openers, opiates and morphinomimetics); and hemostatic agents and antihemorrhagic agents.

### Manufacturing Process

In another aspect of the invention, there is provided a method for manufacturing the matrix of the invention, comprising contacting a viscoelastic polymeric film with a first layer of the elastic polymeric material, thereby obtaining a coated elastic polymeric material comprising a layer of the viscoelastic polymer bound to the elastic polymeric material; and contacting the layer of the viscoelastic polymer with a second layer of the elastic polymeric material, thereby obtaining a multi-layered matrix; wherein viscoelastic polymeric film comprises or consists essentially of the viscoelastic polymer as disclosed herein; and wherein any one of the first/second layer of the elastic polymeric material is as described about comprising or consisting essentially of the electrospun fibers, wherein the polymeric content of the elastic polymeric material comprises or consist essentially of PLLA/CL. In some embodiments, one surface of the viscoelastic polymeric film is in contact with a support layer, or with a mold. In some embodiments, the support layer/mold comprises a glass material.

In another aspect of the invention, there is provided a method for manufacturing the matrix of the invention, comprising:
(i) applying a solution of the viscoelastic polymer on a first layer of the elastic polymeric material, to obtain a coated elastic polymeric material comprising a layer of the viscoelastic polymer bound to the elastic polymeric material;
(ii) contacting the layer of the viscoelastic polymer with a second layer of the elastic polymeric material, thereby obtaining a multi-layered matrix; wherein the viscoelastic polymer comprises or consist of one or more polymers as disclosed herein; and wherein any one of the first/second layer of the elastic polymeric material is as described about comprising or consisting essentially of the electrospun fibers, wherein the polymeric content of the elastic polymeric material comprises or consist essentially of PLLA/CL.

In some embodiments, the multi-layered matrix is a non-sterilized matrix. In some embodiments, the method further comprises sterilizing the non-sterilized (also termed herein as “non-sterile) matrix. In some embodiments, sterilizing composites exposing the non-sterilized matrix to a source of beta radiation, thereby obtaining the matrix of the invention (i.e. sterilized matrix).

In some embodiments, the source of beta radiation is an electron beam. In some embodiments, the method comprises sterilizing the multi-layer matrix by irradiating thereof with a beta radiation dose suitable for sterilization of the multi-layer matrix. In some embodiments, the beta radiation dose is between 10 and 50 kGy, between 20 and 25 kGy, between 15 and 25 kGy, between 15 and 30 kGy, including any range between.

In some embodiments, the first/second layer of the elastic polymeric material is characterized by average thickness in a range of from 20 to 500 μm, from 25 to 350 μm, from 50 to 250 μm, or from 80 to 200 μm, including any range between.

In some embodiments, the PLLA/CL is characterized by Mw of between about 115 and about 120 kDa, and by a molar content of caprolactone between about 20 and about 40%, or about 30%.

In some embodiments, the viscoelastic polymeric film is between 70 and 300 um, between 80 and 200 um, between 80 and 150 um, between 100 and 300 um, between 100 and 200 um, between 70 and 100 um, between 70 and 150 um thick (e.g. average thickness), including any range between.

In some embodiments, the polymeric content of the viscoelastic polymeric film comprises or consist essentially of PDLCL characterized by Mw between about 60 and 65 kDa, and by Mn between about 40 and 45 kDa. In some embodiments, the layer is a PDLCL film or layer, as disclosed hereinabove, and is characterized by average thickness between 70 and 300 um, and consisting essentially of PDLCL characterized by Mw between about 60 and 65 kDa, and by Mn between about 40 and 45 kDa; and wherein PDLCL is characterized by a molar percentage of caprolactone between about 70 and about 80%, or about 75%.

In some embodiments, the viscoelastic polymer is PDLCL characterized by MW between about 60 and 65 kDa, and by Mn between about 40 and 45 kDa. In some embodiments, the Mw/Mn of the PDLCL and of the PLCL mentioned herein are determined based on inherent viscosity of the polymer.

In some embodiments, the viscoelastic polymer is further characterized by a molar percentage of caprolactone between about 70 and about 80%. In some embodiments, the viscoelastic polymer is characterized by: any one of (i) a melting peak temperature between 32.5 and 45° C., between 32.5 and 38° C., (determined by DSC), and (ii) inherent viscosity between 0.83 and 0.9 dl/g, between 0.84 and 0.9 dl/g, between 0.84 and 0.89 dl/g, between 0.85 and 0.9 dl/g, including any range between; or the viscoelastic polymer is characterized by (i) and (ii). The melting peak temperature and the inherent viscosity are determined as described in Materials and Methods. Noteworthy, the Tm of raw polymer and of the same polymer included in the multi-layer matrix of the invention have different values.

In some embodiments, the viscoelastic polymeric film is obtained by shaping or molding a solution of the viscoelastic polymer. In some embodiments, the shaping or molding is performed by casting (e.g. solution casting). In some embodiments, casting comprises film casting.

In some embodiments, casting comprises contacting a sufficient amount of the solution with the support material or with a mold, to obtain a film; and further comprises a partial drying of the film, thereby obtaining a settled viscoelastic film. In some embodiments, the settled viscoelastic film is a non-flowable film (i.e. devoid of free flowability). In some embodiments, the settled viscoelastic film has a reduced organic solvent content, compared to the solution of the viscoelastic polymer. In some embodiments, reduced organic solvent content comprises reduction by at least 10%, at least 20%, at least 30% at least 50%, at least 60%, or between 10 and 80%, between 10 and 70%, between 10 and 60%, between 10 and 50%, between 10 and 40%, between 10 and 30% reduction, including any range between.

In some embodiments, the solution of the viscoelastic polymer is an organic solution comprising the viscoelastic polymer and an organic solvent, wherein the organic solvent is capable of dissolving the viscoelastic polymer at a temperature between 2° and 40° C. In some embodiments, the organic solvent comprises one or more solvents. In some embodiments, the organic solvent comprises a water-immiscible solvent. In some embodiments, the organic solvent comprises a water-immiscible solvent aprotic solvent. In some embodiments, the organic solvent comprises an ether based solvent. In some embodiments, the ether based solvent is characterized by a boiling point between 4° and 120° C. Examples of ether solvents include tetrahydrofuran (THF), 1,4-dioxane, diethyl ether, dimethoxyethane (glyme), diisopropyl ether, methyl tert-butyl ether (MTBE), ethyl tert-butyl ether (ETBE), dibutyl ether, anisole, and tetraethylene glycol dimethyl ether (tetraglyme).

In some embodiments, the organic solvent further comprises an amide-based solvent. In some embodiments, the amide-based solvent is characterized by a boiling point between 12° and 300° C. Examples of amide-based solvents include dimethylformamide (DMF), dimethylacetamide (DMAc), N-methyl-2-pyrrolidone (NMP), N,N-diethylacetamide (DEAc), N,N-dimethylpropionamide (DMPA), N,N-dimethylbutyramide (DMBA), N,N-dimethylisobutyramide (DMIBA), N,N-dimethylvaleramide (DMVA), N,N-dimethylcaproamide (DMCA), and N,N-dimethylbenzamide (DMBA).

In some embodiments, a w/w concentration of the viscoelastic polymer in the solution is between about 20 and about 60%, between about 25 and about 35%, between about 20 and about 40%, between about 20 and about 50%, including any range between.

In some embodiments, a w/w concentration of DMF in the solution is below 30%, below 25%, below 20% or between about 5 and about 15%, between about 5 and about 10%, between about 7 and about 12%, between about 7 and about 10%, between about 10 and about 15% v/v, including any range between. In some embodiments, the organic solvent in the solution is or comprises DMF and further comprises THF, dioxane or both. In some embodiments, the organic solvent in the solution is or comprises DMF, THF and dioxane, wherein a w/w concentration of DMF in the solution is below 30%, below 25%, below 20% or between about 5 and about 15%, between about 5 and about 10%, between about 7 and about 12%, between about 7 and about 10%, between about 10 and about 15% v/v, including any range between.

In some embodiments, contacting the layer of the viscoelastic polymer (i.e. the settled viscoelastic film) with the second layer further comprises applying pressure to the multi-layered matrix, thereby inducing bonding of the first and of the second layers to the viscoelastic polymeric film. In some embodiments, the pressure is applied using any suitable pressure source such as a mechanical press, hydraulic press, pneumatic press, or roller press, to ensure adequate bonding and integration of the layers within the multi-layered matrix.

In some embodiments, the pressure applied to the multi-layered matrix is at least 50 Pa, at least 70 Pa, at least 100 Pa, or between 50 and 1000 Pa, including any range between.

In some embodiments, the method further comprises drying the multi-layered matrix, to obtain a dried matrix. In some embodiments, drying is performed before sterilization.

In some embodiments, the method further comprises drying the multi-layered matrix, to obtain a dried matrix. In some embodiments, drying is performed before sterilization (by beta radiation). In some embodiments, drying comprises vacuum drying, heat-drying, or both. Additional drying processes that could be used include:
1. Vacuum Drying: This process involves removing moisture under reduced pressure, which lowers the boiling point of water and allows drying at lower temperatures, preserving the material's integrity.
2. Freeze Drying (Lyophilization): This method involves freezing the material and then reducing the surrounding pressure to allow the frozen water to sublimate directly from solid to gas, ideal for heat-sensitive materials.
3. Desiccant Drying: Using desiccants like silica gel or molecular sieves to absorb moisture from the material in a controlled environment.
4. Infrared Drying: Utilizing infrared radiation to heat and evaporate moisture from the material's surface, providing rapid and uniform drying.
5. Microwave Drying: Employing microwave energy to heat and evaporate moisture, offering fast drying times and energy efficiency.

These methods can be selected based on the material's properties and the desired drying efficiency.

In some embodiments, the dried matrix is characterized by a total residual solvent content of up to 0.5%, up to 0.2%, or up to about 0.1% by weight. In some embodiments, the total residual solvent content comprises one or more from THF (e.g. below 1000 ppm), dioxane, and DMF. In some embodiments, the total residual solvent content comprises one or more from THF (e.g. below 1000 ppm or below 800 ppm), dioxane (e.g. below 1000 ppm or below 800 ppm), and DMF below 800, below 500, below 200, below 100 or below 88 ppm.

In some embodiments, the dried matrix is characterized by (i) a residual solvent content of up to 0.2%; and (ii) water content of up to 5%, up to 2% or up to 1% relative to a total weight of the dried matrix. In some embodiments, the dried matrix is characterized by (i) a residual solvent content of up to 0.2%; (ii) residual DMF content below 100 ppm or below 88 ppm and (iii) water content of up to 5%, up to 2% or up to 1% relative to a total weight of the dried matrix.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure. For example, the term “consisting essentially of” may encompass that at least 80%, at least 90%, at least 92%, at least 95%, at least 97%, at least 98%, at least 99%, or between 80 and 100%, between 80 and 99%, between 90 and 95%, between 90 and 96%, between 90 and 97%, between 90 and 98%, between 93 and 97%, between 93 and 98%, between 93 and 99%, between 95 and 99%, between 96 and 99%, between 97 and 99% by weight of the composition (e.g. of the matrix, or any of the matrix layers) including any range or value therebetween consists of the listed ingredient(s).

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict. The words “further” and “optionally” may be used interchangeably.

As used herein, the singular form “a”, “an” and “the” include plural references unless the context clearly dictates otherwise. For example, the term “a compound” or “at least one compound” may include a plurality of compounds, including mixtures thereof.

As used herein, the term “substantially” is at least 80%, at least 90%, at least 92%, at least 95%, at least 97%, at least 98%, at least 99% by weight of the composition including any range or value therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treatment” or “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

Herein throughout, the phrase “elastic modulus” refers to Young's modulus, as determined by response of a material to application of tensile stress (e.g., according to procedures described in the Examples section herein).

Tensile properties described herein (e.g., elastic modulus, elongation at failure, recovery and ultimate tensile strength) are determined in accordance with ASTM international standard D882-12 for testing tensile properties of thin plastic sheeting. Except where indicated otherwise, the tensile properties are determined after or before the layers are immersed in aqueous liquid (e.g., water, phosphate buffer saline), and at a temperature of 37° C. (e.g., according to procedures described in the Examples section herein). Tensile testing characterizes an amount of tensile stress applied to the tested material as a function of tensile strain (increase in length due to tensile stress, as a percentage of the original length) of the material.

The ultimate tensile strength is determined as the maximal stress which can be applied to the tested material, such that any further strain is obtained with reduced stress (a phenomenon known as “necking” or is unobtainable because the tensile stress results in rupture (e.g., tearing, cracking) of the material.

The elongation at failure is determined as the maximal strain (elongation) which can occur (upon application of tensile stress equal to the ultimate tensile strength) before failure of the tested material occurs (e.g., as rupture or necking).

The elastic modulus is determined as the gradient of stress as a function of strain over ranges of stress and strain wherein stress is a linear function of strain (e.g., from a stress and strain of zero, to the elastic proportionality limit, and optionally from zero strain to a strain which is no more than 50% of the elongation at failure).

Recovery is determined by releasing the tensile stress after subjecting the tested material as the ratio of the decrease in length to a prior strain after a material (e.g., elastic layer) is subjected to a prior strain which is almost equal to the elongation at failure (optionally about 80 or about 90% of the elongation at failure, optionally about 95% of the elongation at failure, optionally about 98% of the elongation at failure, optionally about 99% of the elongation at failure, wherein the elongation at failure can be determined using an equivalent sample). Recovery is measured under ambient conditions (pressure of about 1 atm and a temperature between 19 and 30° C.).

Thus, for example, a material extended to an elongation at failure which is 200%, and which upon release of tensile stress returns to a state characterized by a strain of 20% relative to the original length, would be characterized as having a recovery of 90% (i.e., 200%-20% divided by 200%).

As used herein, the term “biocompatible” refers to a material which the skilled practitioner would expect the body to generally accept without significant toxicity, immune response and/or rejection, or excessive fibrosis. In some embodiments, a moderate degree of immune response and/or fibrosis may optionally be acceptable or desired.

The term “biodegradable” as used in the context of the present invention, describes a material which can decompose under physiological and/or environmental conditions into breakdown products (e.g. polymer fragments, monomers, CO2, methane, or other gases). Such physiological and/or environmental conditions include, for example, hydrolysis (decomposition via hydrolytic cleavage), enzymatic catalysis (enzymatic degradation), and mechanical interactions, or under composting conditions such as wet soil exposed to ambient temperature (e.g. between 0 and 40C), ambient air atmosphere, ambient pressure (e.g. about 1 atm). This term typically refers to substances that decompose under these conditions such that between 90 and 100% of the substance decompose within a time period shorter than one year, or a time period between 1 week and 1 y, between 1 w. and 0.5 y, including any range between.

The term “biodegradable” as used in the context of the present invention, also encompasses the term “bioresorbable”, which describes a substance that decomposes under physiological conditions to break down to products that undergo bioresorption into the host-organism, namely, become metabolites of the biochemical systems of the host-organism.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

### EXAMPLES

### Materials and Methods

### Inherent Viscosity

### Single Point Method (Chloroform)

0.250 of polymer is weighed into a 50 ml volumetric flask. About 25 ml of chloroform is added to the flask, and the mixture is shaken until the polymer is dissolved. The minimum dissolution time is set at an overnight period. The solution is stable for a maximum of 72 hours.

The solution is filled up to 50 ml, and shaken a couple of times. The water bath is turned on and set to 25° C. Before a measurement is performed, the temperature of the water bath must be checked. The viscometer is rinsed two times with chloroform, and is then filled with chloroform. Solutions or solvents should always be added to the viscometer through a glass filter to avoid the introduction of solid particles into the viscometer.

The blank is measured using the Win Visco software. Subsequently, the viscometer is rinsed twice with the polymer solution, after which it is filled. The sample is measured using the WinVisco software. When a very viscous solution has been measured (t>160 s), the viscometer should be rinsed twice with chloroform before the next sample is measured.

### Single Point Method (HFIP)

When a polymer doesn't dissolve in chloroform, HFIP is used as a solvent. The same amount of polymer is weighted, but now the polymer is weighed into a 25 ml volumetric flask. The polymer can be dissolved more quickly by using a fine fraction of the sample, i.e. <1 mm. If this is not sufficient or achievable the solution can be heated to a maximum of 35° C. in order to get a totally dissolved polymer solution.

The method is the same as for chloroform, with the exception that HFIP is used to clean the viscometer, and that the viscometer at the end of the measurements isn't rinsed and filled with chloroform, but with acetone. Blank and sample are measured using the Win Visco software.

### Win Visco

Flow time measurements of blank and sample are controlled by WinVisco software. Variables can be set in the software and with these variables the Inherent Viscosity is calculated. The software uses Hagenbach correction to correct flow times of Ubbelohde Din 0c viscometers.

Average flow time is calculated from 3 flow time measurements. The software uses a maximum deviation setting that determines which flow times can be used to calculate the average (when more than 3 flow times are acquired). When the maximum deviation setting has not been met after 5 measurements, the blank or sample has to be discarded and the tube refilled. It is not allowed to derive an average flow time from more than 5 measurements.

### Calculations

The software calculates the Inherent Viscosity using the corrected average value, entered volume solution and sample weight. In case the sample was poly(L-lactide), poly(D-lactide) or poly (DL-lactide), the viscosity average molecular weight can be calculated using Mark-Houwink parameters and equation 6.

The Mark-Houwink parameters for poly(L-lactide) and poly(D-lactide) are: K=5.45·10⁻⁴ and a=0.73.

$$Corrected flow time {t}_{c} = {t}_{u} - {t}_{𝔹 c} \qquad Equation 1$$

$$Relative viscosity {η}_{rel} = \frac{{t}_{s}}{{t}_{b}} \qquad Equation 2$$

$$Specific viscosity {η}_{sp} = \frac{( {t}_{s} - {t}_{b} )}{{t}_{b}} \qquad Equation 3$$

$$Intrinsic viscosity {η}_{intr} = \frac{( \sqrt{2 \cdot {η}_{sp} - 2 \cdot in {η}_{rel}} )}{c} \qquad Equation 4$$

$$Inherent viscosity {η}_{inh} = \frac{in {η}_{rel}}{c} \qquad Equation 5$$

$$Molecular weight {M}_{v} = {[ \frac{{η}_{intr}}{K} ]}^{( \frac{1}{a} )} \qquad Equation 6$$

$$Kinematic viscosity {η}_{kin} = {K}^{′} \times {t}_{c} \qquad Equation 7$$

### Where:

tc=Corrected flow time [s]
tu=Uncorrected flow time [s]
thc=Hagenbach Correction [s]
ts=Corrected sample flow time [s]
tb=Correct blank flow time [s]
c=concentration [g/dl]
Mv=viscosity average molecular weight [g/mol]
K, a=Mark-Houwink parameters
ηrel=relative viscosity [−]
ηsp=specific viscosity [−]
ηintr=intrinsic viscosity [dl/g]
ηinh=inherent viscosity [dl/g]
K′=Ubbelohde tube constant [mm2/s2]

The Maximum deviation is calculated by the software according to equation 8.

$$Maximum deviation \frac{\vert {t}_{x} - {t}_{average} \vert}{{t}_{average}} \times 100 \% \qquad Equation 8$$

### Where:

tx=flow time of measurement 1 or 2
taverage=average flow time of measurement 1 and 2.

### DSC

DSC was measured on TA Instruments Trios V5.0.0.44616 by utilizing 5-10 mg sample, at a temperature range from −60° C. to +60° C. (or +180° C.) at a heating rate of 10° C. min⁻¹

### Degree of Crystallinity

The term “crystallinity” as used herein, refers to a value calculated from a DSC graph of (i) the raw polymer, i.e. PDLCL or PLLCL (when determining the crystallinity of the raw material, such as for use in the manufacturing method disclosed herein) or (ii) the article/multi-layered matrix.

The calculation of the crystallinity degree (Xc) is performed according to the following equation:

$$Xc ( \% ) = \frac{1 \; 00 Δ {H}_{f}}{Δ {H}_{f}^{0} \cdot ( LA \text{*)}}$$

where ΔH⁰f is the enthalpy of fusion of PLLA crystals having the infinite crystal thickness (see Sarasua, J. R., Prud'homme, R. E., Wisniewski, M., Le Borgne, A., Spassky, N., 1998. Macromolecules 31, 3895-3905), ΔHf is the total normalized enthalpy obtained for the phase transitions (such as for Tc and Tm) of the polymer (PDLCL or PLLCL) and (LA*) is the lactide mass fraction in the copolymer. Here, ΔH⁰f is 106 (J g⁻¹).

### Swelling Test

The test is performed in a sealed container containing phosphate buffered saline (PBS, pH 7.4). The test sample is immersed into PBS and is incubated for 7 days at 37° C.±1° C. The average thickness of the sample is measured before incubation (t₀) and after incubation (t₁) using an optical microscope with an image analysis software. The swelling ratio is determined by dividing t₁ by t₀.

### Example 1

Exemplary article of the invention has been manufactured as follows.

The viscoelastic polymeric film has been prepared by film casting by smearing a polymer solution along a glass surface using a film applicator. PDLLA/CL (PDLC 2509 obtained from Corbion, or alternatively Evonik, Nomisma Healthcare) characterized by a molar percentage of caprolactone of about 75%, and by MW of about 64 kDa (viscosity based) was dissolved in a mixture of THF:DMF:dioxane, and the resulting 30% w/w solution was applied to a glass surface using a film applicator to form a thin film (about 150 micron) that was pre-adjusted to the required thickness.

After partially drying of the viscoelastic polymeric film (i.e. settling, by air drying for ~1-10 min in a hood) a first electro-spun PLCL strip (obtained by electrospinning a solution of PLCL characterized by MW of between about 115 and about 120 kDa) is laid against first surface of the film and pressure is applied to achieve complete attachments of both layer to each other. Subsequently, a second electro-spun PLCL strip is applied to the second surface of the viscoelastic polymeric film. Pressure is applied (plastic weight on top of the sandwiched matrix) again to ensure full integration of the third layer. The obtained three-layer patch is then dried to fully remove solvents residues (e.g. below the following max. threshold values: THF 720 ppm, Dioxane 380 ppm, DMF 88 ppm).

More detailed description of the fabrication condition is provided in PCT/IL2014/051109, which is incorporated herein by reference in its entirety.

Further, the manufactured three-layer patch was sterilized by beta radiation (e-beam, radiation dose between 17 and 25 kGy), to obtain a sterile article (sterile patch).

### Example 2

The sterile article from Example 1 has been tested for its chemical composition, as well as physico-mechanical properties, and compared to non-sterilized and to gamma sterilized article. The results of these tests are summarized below. Further, due to technical challenges in determining the molecular weight parameters of PLCL in the three-layer patch, the inventors used electro-spun PLCL sheet from Example 1 (instead of the 3-layer patch) and compared the non-irradiated sheet with beta/gamma-irradiated sheets.

Surprisingly, the inventors observed that beta-radiation sterilized PLCL has been characterized by significantly lower Mw/Mn reduction (determined by GPC), as compared to gamma-irradiated counterpart (see table 3 below).

TABLE 3

| Sample name | Mw (Da) | Mn (Da) | Mz (Da) |
|---|---|---|---|
| Non-sterile PLCL N-1 Sheet | 118655 | 72774 | 266235 |
| Beta sterilized PLCL N-1 T0 Sheet: | 83995 | 48498 | 166845 |
| | 86363 | 50634 | 177910 |
| Gamma sterilized PLCL N-1 Sheet | 73322 | 45106 | 133905 |
| | 76523 | 46864 | 141850 |
| % change after Beta sterilization | −28 | −32 | −35 |
| % change after Gamma sterilization | −37 | −37 | −48 |

Non-limiting test results of example gamma/beta irradiated patches, along with test methods, are summarized below.

### Test No.: 1 (Tensile Evaluation)

The purpose of this test procedure was to evaluate: (a) the ultimate tensile strength (UTS) [MPa] of the tested patch, and (b) the elongation at tearing [%], upon the application of a direct tensile force.

### Test Method

“Dog-bone” shaped test articles were cut from each patch and mounted upon a designated extension machine. The tensile test was performed at a constant speed of 50 mm/min. The maximal force and displacement for each test article was documented accordingly.

### Sample Size Consideration

In order to evaluate the average and to calculate a 95% confidence interval for continuous parameter and to maintain type I error of 5% (=α) and power of at least 80% (=1−β), the minimal sample size is 10; this number does not include dropouts due to unrelated technical failures (normally estimated in 10% to 20%). At least 30 products from different batches were tested.

### Results

For gamma irradiated test articles, the minimal UTS value was: 3.07 MPa, and the minimal elongation before break value was: 154%.

For beta irradiated test articles, the minimal UTS value was: 5.04 to about 7 MPa, and the minimal elongation before break value was: 369%.

With respect to the non-irradiated articles, the beta irradiated patches almost retain the elongation (reduction of not more than 5%, relative to non-irradiated patches); and showed only about 30% reduction in the UTS.

### Test No.: 2 (Suture Retention Evaluation)

The purpose of this test procedure was to evaluate suture retention strength of the tested patch and to compare it to a control product-Suturable Duragen® by Integra.

### Test Method

Suture retention tests were adapted from the method described in ANSI/AAMI/ISO 7198: 1998/2001/(R) 2004 standard and ASTM D882-12: Standard test method for tensile properties of thin plastic sheeting. At least three tested patches and 3 patches of DuraGen® were cut and immersed in PBS for 15 min before the test. One end of the dog bone shaped sample was removed by scalpel and the sample was sutured (suture type: Premilene™, 4/0) at a minimum distance of 2 mm from its free end. The sample was then placed on the tensile machine, by connecting the patch to the first grip and the suture to the other one. Tensile test was carried out using LLOYD LS1 uniaxial tensile machine (equipped with a 10 N load cell for gamma irradiated products testing and a 100N load cell for Beta irradiated products testing) to measure the force at failure of the samples.

Note: Duragen was similarly tested in both test apparatus for comparison reasons.

### Sample Size Consideration

This test was conducted for investigational purposes and no statistical analysis was performed.

### Results

For gamma irradiated patches, the mean force to breakage was 1.1±0.03 N and was greater than the mean force to breakage of DuraGen −0.86±0.2 N.

For beta irradiated patches, the mean force to breakage was 4.19N±0.233 N and was greater than the mean force to breakage of DuraGen −1.15±0.36 N. Non-irradiated patches showed substantially the same values (or even slightly lower) as beta irradiated patches.

### Test No.: 3 (Burst Pressure Test)

The purpose of this test procedure was to evaluate the burst pressures that the tested patch can withstand before failing and/or leaking, upon the application of a constant rate of saline flow.

### Test Method

A burst pressure test was performed in accordance with ASTM F2392-04—“Standard Test Method for Burst Strength of Surgical Sealants,” with some modifications. A custom-made testing apparatus was built according to the ASTM. Each evaluated test article was mounted upon a test fixture base and secured with an O-Ring. Saline were injected into the test fixture at a flow rate of 2 ml/min and burst strength was calculated for each sample as the peak pressure that allowed fluid leakage from the sample.

### Sample Size Consideration

In order to evaluate the average and to calculate a 95% confidence interval for continuous parameter and to maintain type I error of 5% (=α) and power of at least 80% (=1−β), the minimal sample size is 10; this number does not include dropouts due to unrelated technical failures (normally estimated in 10% to 20%). At least 30 products from different batches were tested.

Results for gamma irradiated patches, the minimal pressure measured was: 1 psi.

For beta irradiated patches, the minimal pressure measured was: 3 psi.

Another test was performed comparing the beta irradiated patches with non-irradiated patches. The non-irradiated patches exhibited an average burst pressure of about 2.5 psi, whereas beta irradiated patches exhibited an average burst pressure of about 1.55 psi.

To this end, the inventors surprisingly observed that despite the same radiation dose the tested patches were exposed to, beta irradiated patched exhibited (i) improved physico-mechanical properties and (ii) higher Mw/Mn values of the PLCL, compared to gamma irradiated article (patch).

Thus, the inventors observed that beta-radiation sterilized three-layer patch substantially retained the physico-mechanical properties of the non-irradiated article. In contrast, gamma-radiation sterilized three-layer patch showed significant impaired physico-mechanical properties, as compared to the non-irradiated article (see below). Accordingly, the inventors concluded that sterilization of the three-layer patch by beta-radiation is unexpectedly highly preferable over gamma-radiation based sterilization.

### Example 3

The inventors observed a correlation between the Tm of PDLCL and the swelling properties of the patch (matrix) of the invention. In brief, different production batches of the PDLCL obtained from the manufacturer were used for fabrication of the patch, as disclosed in Example 1. Subsequently, the Tm of the PDLCL in the as-prepared patch (form each batch) was determined by DSC (exemplary Tm is shown in FIG. 1).

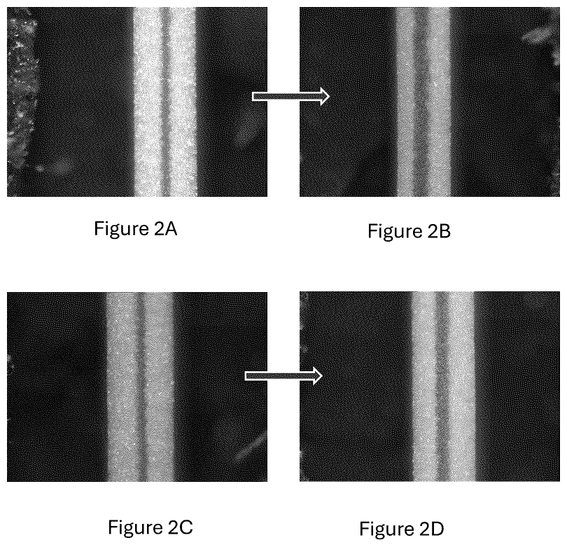

Further, each of the patched was subjected to a swelling test (describe hereinabove), to determine its swelling ratio (i.e. swelling ratio of the viscoelastic PDLCL film) and the obtained swelling ration were compared with the measured Tm of the PDLCL in the as-prepared patch. Exemplary patches before and after swelling test are presented in FIGS. 2A-D.

The inventors have surprisingly observed that control patches (not according to the present invention) including PDLCL having a Tm of 28.6° C. and an inherent viscosity of 0.81 dl/g exhibited a significantly higher average swelling ratio of 2.5 (see FIG. 2B) compared to average swelling ratio of only 1.4 of exemplary patches of the invention (FIG. 2D) including PDLCL having a Tm of 34.7° C. and inherent viscosity of 0.85 dl/g.

Furthermore, the inventors performed numerous tests with patches having varying thickness of the viscoelastic polymeric film. The inventors observed that patches having a thickness of the viscoelastic polymeric film below 10 um underwent fats disintegration. It has been postulated that a thickness of the viscoelastic polymeric film below 10 um is insufficient to held together the layers of the elastic polymeric material.

In an additional experiment, control patches including the viscoelastic polymeric film with a thickness above 60 um (e.g. 80-100 um) and exemplary patches of the invention including the viscoelastic polymeric film with a thickness between 20 and 60 um were tested in-vivo (by implanting thereof into mice). Surprisingly, control patched underwent disintegration/detachment from the tissue in-vivo, whereas the patches of the invention remained stable during the tested time period.

### Example 4

This study aims to develop a method for optimizing the manufacturing process of the product to reduce residual DMF concentration (post-drying) below regulatory limits in the final product while preserving its performance, mechanical properties, and solution viscosity. Using a standard PDLCL solution for the manufacture of the viscoelastic layer requires prolonged drying times (between 7-14 days at RT under vacuum). Accordingly, in order to increase the efficiency of the entire manufacturing process, the inventors aimed to drastically reduce the drying time (preferably not more than 48 h), while meeting the upper DMF residual content set by the regulatory authorities.

The influence of DMF concentration on the PDLCL solution of Artifascia® was systematically investigated, starting from standard concentration (Standard %). Modified formulations were prepared with reduced concentrations of Medium %, Low %, and a DMF-free solution (Zero %)—Standard %>Medium %>Low %>Zero %. The standard PDLCL solution used herein was a 30% w/w PDLCL solution in a solvent mixture of DMF:THF:dioxane, with the following solvent ratios 17.5:35:17.5, respectively.

The study evaluated key parameters including solution properties, viscosity characteristics, polymer solubility, processability, and final product functionality. Analytical methods encompassed polymer dissolution behavior, stability analysis, and solution viscosity profiles under controlled experimental conditions.

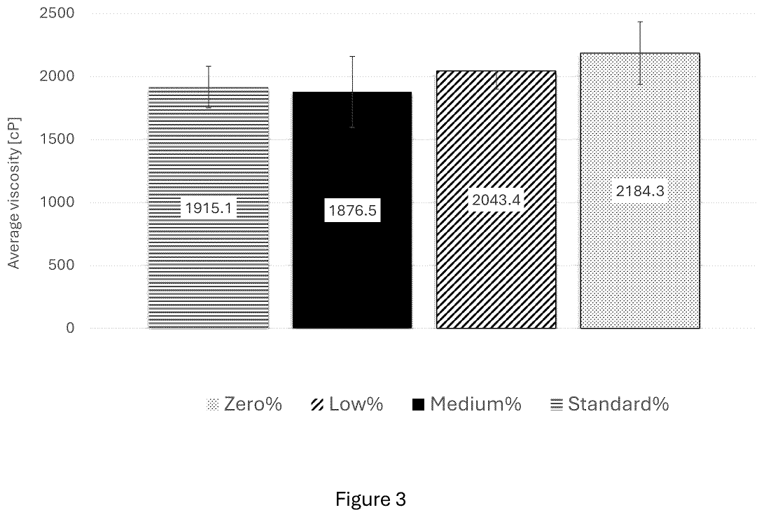

PDLCL solutions with decreasing concentrations of DMF were tested for their potential use in the manufacturing of Artifascia®. PDLCL solution produces a thin film using a film applicator, where the film quality is highly dependent on the solution's rheological properties (viscosity). Since significant variations in solution viscosity can adversely affect the film quality, it is crucial to maintain consistent rheological properties. Viscosity tests (FIG. 3), each repeated three times, were performed to determine the properties of DMF solutions at various concentrations, including medium %, low %, zero %, and a standard % as a standard concentration used in regular Artifascia® process production. (standard %>medium %>low %>zero %)

A trend of increasing viscosity is observed as the percentage of DMF in the solutions decreases. The solution with low and medium % DMF exhibits a viscosity similar to the standard % DMF solution (p>0.05).

presents the mechanical properties and thickness measurements of Artifascia® patches fabricated using PDLCL solutions with different DMF concentrations, namely Standard % (i.e. 17.5% v/v), Medium % (i.e. 10% v/v) and Low % (i.e. 5% v/v). The results show tensile strength, elongation percentage, and PDLCL middle layer thickness for each concentration. The Zero % DMF solution failed to produce a viable product.

TABLE 4
Tensile and thickness results of Artifascia ® prepared
using different PDLCL solutions

| | PDLCL middle | Strength | Elongation |
|---|---|---|---|
| % DMF | layer thickness [μm] | [N] | [%] |
| Standard | 33.2 ± 9.6 | 10 ± 0.7 | 470 ± 28 |
| Medium | 33.9 ± 3.6 | 8.8 ± 1.1 | 503 ± 20 |
| Low | 39.8 ± 5.1 | 8.0 ± 1.6 | 510 ± 35 |

| | |
|---|---|
| Zero | NA |

As DMF concentration decreases, strength also decreases, the thickness of the PDLCL layer increases and the elongation initially decreases at medium % DMF but subsequently increases at low % DMF. The results obtained are all within the product's specifications, therefore such solutions can be used.

The findings demonstrate a clear relationship between DMF concentration, solution viscosity, and the ability to produce Artifascia® patches. An inverse relationship was found between DMF concentration and viscosity—as DMF concentration decreases, viscosity increases. Viscosity above 2050 cP proved problematic for the manufacturing process, as seen in the DMF-free solution (2184.3 cP) which made production impossible.

In contrast, medium % and standard % concentrations showed lower viscosity (1876.5 cP and 1915.1 cP respectively) with no statistically significant difference between them (p>0.05), leading to similar processing characteristics and successful production.

Although the low % DMF concentration (2043.3 cP) had a viscosity closer to the medium % and standard % concentrations, it presented manufacturing challenges, though production was still achievable. When examining the mechanical properties of the patches, significant differences emerge: reducing DMF concentration to medium % and low % led to a 12% and 20% decrease in strength respectively, while showing improved elongation properties.

Regarding the PDLCL middle layer thickness, standard % and medium % patches showed similar measurements, while low % patches were thicker. Importantly, despite these variations, all results remained well within the product's specifications, confirming the viability of these modified solutions for production use.

Overall, medium % concentration presents the optimal balance between different parameters—it enables efficient production due to low viscosity, maintains better strength than low %, and shows improved elongation compared to standard %. Products formulated with low % and medium % DMF met the upper DMF residual content set by the regulatory authorities (i.e. 88 ppm) and required relatively short drying times 24-48 h.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. An article comprising a multi-layer matrix, said multi-layer matrix comprising a viscoelastic polymeric film sandwiched between two or more layers of an elastic polymeric material; wherein:
each of said two or more layers of the elastic polymeric material is in a form of a fibrous mat;
the fibrous mat comprises a plurality of electrospun fibers characterized by an average cross-section between about 1 and about 5 micrometers;
said viscoelastic polymeric film is characterized by a thickness between about 10 and about 60 um;
said viscoelastic polymeric film is characterized by a melting peak temperature of between about 30 and about 40° C., determined by DSC;
said two or more layers of the elastic polymeric material comprise PLCL characterized by Mw of between 78 and about 100 kDa.

2. The article of claim 1, wherein said multi-layer matrix is a suturable matrix, a stapleable matrix, or both; and wherein said viscoelastic polymeric film is a continuous film characterized by a uniform thickness and by an average pore size between about 5 and about 50 micrometers.

3. The article of claim 1, characterized by a residual content of DMF below 88 ppm.

4. The article of claim 1, wherein said article is characterized by at least one of: (i) an average elongation at failure in a range of at least 200%; (ii) by ultimate tensile strength of between 3.5 and 6 MPa, as determined in accordance with ASTM D882-12: (iii) by elastic modulus in a range of from 0.5 to 2 MPa, as determined in accordance with ASTM international standard D882-12; and (iv) by burst pressure of at least 1.5 psi, measured according to ASTM F2392-04.

5. The article of claim 1, wherein said two or more layers of the elastic polymeric material comprise PLLA/CL characterized by Mw of between 80 and 90 kDa and by Mz between about 150 and about 200 kDa.

6. The article of claim 1, wherein the plurality of electrospun fibers is randomly distributed within said fibrous mat; and wherein said fibrous mat is characterized by porosity in a range of from 40% to 70%.

7. The article of claim 1, wherein the article is a sterile article packaged in a sealed container; and wherein said sterile article is a beta-irradiated article.

8. The article of claim 1, being characterized by at least one property selected from:
ultimate tensile strength of between 3.2 and 8 MPa, when measured according to ASTM D882-12;
elongation at failure from 200% to 700%, when measured according to ASTM D882-12; and
suture retention of at least 1.3N, when measured according to ANSI/AAMI/ISO 7198: 1998/2001/(R) 2004.

9. The article of claim 1, wherein said multi-layer matrix, or each of said two or more layers of the elastic polymeric material is characterized by a self-recovery of at least 90%.

10. The article of claim 1, wherein said viscoelastic polymeric film comprises a PDLLA/CL characterized by a molar percentage of caprolactone between about 70 and about 80%; wherein Mw of the PDLLA/CL is between about 20 and about 60 kDa; a molar percentage of caprolactone of about 75; and wherein Mn of the PDLLA/CL is between about 10 and about 45 kDa.

11. The article of claim 10, wherein between 95 and 100% by weight of viscoelastic polymeric film consists of the PDLLA/CL; and wherein a DSC graph of said article comprises at least one melting peak corresponding to the PDLLA/CL at a temperature between 3° and 40° C.; and wherein the PDLLA/CL is characterized by crystallinity of between 1 and 20%, determined based on DSC.

12. The article of claim 1, wherein a weight content of the plurality of electrospun fibers in each of said two or more layers of the elastic polymeric material is between 95 and 100%; and wherein the plurality of electrospun fibers consist essentially of the PLCL; wherein average thickness of each of said two or more layers of the elastic polymeric material is between about 100 and about 200 μm; and wherein a molar percentage of caprolactone within the PLCL is between about 20 and about 40%.

13. The article of claim 12, wherein the molar percentage of caprolactone is about 30%; and wherein the PLCL is characterized by a melting peak temperature between about 100 and about 120° C.; and optionally by a crystallinity of between 8 and 20%.

14. A method of manufacturing the article of claim 1, comprising:
providing a first layer of the elastic polymeric material, a second layer of the elastic polymeric material and a viscoelastic polymeric film comprising a first surface and a second surface, wherein at least the first surface faces an ambient and the second surface is in contact with a support material, wherein said viscoelastic polymeric film is between 70 and 300 um thick and comprises PDLLA/CL;
contacting said first surface of the viscoelastic polymeric film with the first layer of the elastic polymeric material, thereby obtaining the viscoelastic polymeric film bound to the first layer of the elastic polymeric material;
removing the viscoelastic polymeric film bound to the first layer of the elastic polymeric material from the support material;
contacting said first surface of the viscoelastic polymeric film with the second layer of the elastic polymeric material, thereby obtaining said multi-layered matrix.

15. The method of claim 14, wherein said contacting comprises applying pressure sufficient for binding at least one layer of the elastic polymeric material with at least one surface of the viscoelastic polymeric film; and wherein said pressure is at least 50 Pa; and wherein said method further comprises exposing said multi-layered matrix to conditions suitable for drying to obtain a dried matrix.

16. The method of claim 15, wherein the dried matrix is characterized by a total residual solvent content of below 0.5% by weight; said PDLLA/CL is characterized by a molar percentage of caprolactone (CL) between about 70 and about 80%, and by Mw between about 60 and 65 kDa; wherein the viscoelastic polymeric film consists essentially of said PDLLA/CL and optionally one or more organic solvent, and wherein said PDLLA/CL is characterized by Mw of about 64 kDa, by Mn between about 40 and 45 kDa and by CL content of about 75% mol.

17. The method of claim 14, further comprising a preliminary step of forming the viscoelastic polymeric film, comprising casting a polymeric solution comprising the PDLLA/CL on the support material.

18. The method of claim 17, wherein said casting comprises applying the polymeric solution on the support material to obtain a film; and further comprises a partial drying of the film, thereby obtaining a settled viscoelastic film; wherein said settled viscoelastic film is devoid of free flowability and is characterized by at least 20 weight % reduced organic solvent content, compared to organic solvent content of the polymeric solution; wherein said film is characterized by a thickness of between 70 and 300 um; and wherein a concentration of the PDLLA/CL within the polymeric solution is between 20 and 60% w/w.

19. The method of claim 17, wherein a solvent of the polymeric solution comprises DMF, THF and dioxane; wherein a w/w concentration of DMF in the polymeric solution is below 30%.

20. The method of claim 14, further comprising sterilizing said multi-layer matrix, comprising exposing said multi-layer matrix to beta irradiation at a dose suitable for sterilization of said matrix, thereby obtaining said sterile article.
